(19) United States
(12) Patent Application Publication
(10) Pub. No.: US 2018/0255483 A1
(43) Pub. Date: Sep. 6, 2018

(54) DISTRIBUTION TERMINAL, DISTRIBUTION SYSTEM, AND DISTRIBUTION METHOD

(71) Applicant: FUJITSU LIMITED, Kawasaki-shi (JP)

(72) Inventors: Koji NAKAMICHI, Yokohama (JP); Naoki HASEGAWA, Kawasaki (JP); Yuka TANAKA, Yokohama (JP); Junji ONO, Fukuoka (JP)

(73) Assignee: FUJITSU LIMITED, Kawasaki-shi (JP)

(21) Appl. No.: 15/911,890

(22) Filed: Mar. 5, 2018

(30) Foreign Application Priority Data
Mar. 6, 2017 (JP) 2017-042149

(51) Int. Cl. H04W 28/18; H04L 29/08; H04W 8/00; H04L 1/22

(52) U.S. Cl. CPC H04W 28/18; H04L 67/06; H04W 76/15; H04L 1/22; H04W 8/005

(57) ABSTRACT

A distribution terminal includes a communication unit that receives a request transmitted from an acquisition terminal before wireless communication connection is established, and transmits contents to the acquisition terminal after the wireless communication connection is established; and a processor that controls the communication unit such that transmission limit of the contents is performed based on a number of acquisition terminals when the request is received.

### CROSS-REFERENCE TO RELATED APPLICATION

This application is based upon and claims the benefit of priority of the prior Japanese Patent Application No. 2017-042149, filed on Mar. 6, 2017, the entire contents of which are incorporated herein by reference.

### FIELD

The embodiments discussed herein are related to a distribution terminal, a distribution system, and a distribution method.

### BACKGROUND

Recently, for example, a near field communication function has been provided in a communication device, such as a portable terminal such as a smart phone or a tablet, or an electrical household appliance such as a television or a digital camera. Examples of the near field communication function include a Bluetooth (registered trademark) communication function or a WiFi (registered trademark, wireless fidelity) direct function.

For example, in a distribution system using a WiFi direct function, there is a case where an acquisition terminal such as the portable terminal or the like is sequentially connected to a plurality of peripheral distribution terminals in a near field communication range, and thus, information is acquired. The WiFi direct function has a device discovery function of discovering a device having a WiFi direct function in a near field communication range and a service discovery function of discovering service information provided by the discovered device, in addition to a wireless communication connection function or an information transmission function between terminals.

In the distribution system using the WiFi direct function, the acquisition terminal is capable of discovering a distribution terminal existing in a near field communication range by using a WiFi direct service discovery request message. That is, the acquisition terminal is capable of discovering the distribution terminal existing in the near field communication range as the discovery of the device. For example, the acquisition terminal transmits the WiFi direct service discovery request message in near field communication, and receives the service discovery response message from the distribution terminal, and thus, discovers the distribution terminal existing in the near field communication range. In addition, the acquisition terminal performs WiFi connection, as wireless communication connection with respect to the discovered distribution terminal, and thus, is capable of acquiring the contents retained in the distribution terminal from the discovered distribution terminal. Accordingly, a user of the acquisition terminal is capable of browsing the contents.

In addition, in the distribution system using the WiFi direct function, the acquisition terminal is capable of acquiring meta-information of the contents from the discovered distribution terminal before the contents are acquired from the discovered distribution terminal, when the distribution terminal in the near field communication range is discovered. That is, the acquisition terminal is capable of discovering the meta-information of the contents (contents-relevant information) retained by the distribution terminal, as the discovery of the service information. For example, the distribution terminal distributes the contents-relevant information relevant to the contents by using the WiFi direct service discovery response message. The contents-relevant information is included in the service discovery response message. The acquisition terminal receives the service discovery response message from the distribution terminal, and thus, is capable of acquiring the contents-relevant information from the service discovery response message.

Thus, in the distribution system using the WiFi direct function, the acquisition terminal is capable of acquiring the contents-relevant information from the discovered distribution terminal before the contents are acquired from the discovered distribution terminal in the near field communication range.

In addition, in the distribution system using the WiFi direct function, one distribution terminal retains a plurality of contents different from each other, and thus, is capable of distributing the plurality of contents to each acquisition terminal.

Patent Literature 1: Japanese Laid-open Patent Publication No. 2012-199884

However, in a case where one distribution terminal distributes the plurality of contents to the acquisition terminal, a decrease in processing performance is assumed on the distribution terminal side. Specifically, for example, in a case where one distribution terminal distributes the plurality of contents, a frequency that a content transmission request is transmitted from a plurality of acquisition terminals to one distribution terminal increases, compared to a case where one distribution terminal distributes one content. Accordingly, when one distribution terminal distributes the plurality of contents, an increase in a transmission band is assumed. For this reason, there is a possibility that a throughput for the distribution terminal to transmit the contents per the acquisition terminal decreases. In a case where the throughput decreases, time for transmitting the contents (transmission time) increases. In a case where the transmission time increases, it takes time from the request for the contents of the acquisition terminal to the distribution of the contents, and convenience of a user of the acquisition terminal may decrease.

In order to solve the problem, it is desirable to distribute an access from the acquisition terminal to the distribution terminal. For example, a plurality of distribution terminals are provided in the same portion with respect to each of the contents, and thus, the content transmission request transmitted from the acquisition terminal is distributed, and it is possible to prevent an increase in a content transmission amount from one distribution terminal to the acquisition terminal. However, the plurality of distribution terminals are provided in the same portion, and thus, there is a demerit that the cost for a device (the distribution terminal), management, and the like increases, or an operation labor for the storage of the contents, setting, and the like increases.

### SUMMARY

According to an aspect of an embodiment, a distribution terminal includes a communication unit that receives a request transmitted from an acquisition terminal before wireless communication connection is established, and transmits contents to the acquisition terminal after the wireless communication connection is established; and a processor that controls the communication unit such that transmission limit of the contents is performed based on a number of acquisition terminals when the request is received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a distribution system of this example;

FIG. 2 is a sequence diagram illustrating an example of a distribution service using a WiFi direct function;

FIG. 3 is a diagram illustrating an example of contents-relevant information list-displayed on an acquisition terminal;

FIG. 4 is a block diagram illustrating an example of a hardware configuration of a distribution terminal in the distribution system of this example;

FIG. 5 is a block diagram illustrating an example of a functional configuration of a RAM and a CPU in a distribution terminal of a distribution system of a first example;

FIG. 6 is a diagram illustrating an example of a content storage unit in the distribution terminal of the distribution system of the first example;

FIG. 7 is a block diagram illustrating an example of a hardware configuration of the acquisition terminal in the distribution system of this example;

FIG. 8 is a block diagram illustrating an example of a functional configuration of a CPU in the acquisition terminal of the distribution system of the first example;

FIG. 9 is a flowchart illustrating an example of transmission limit processing, as an operation of the distribution terminal in the distribution system of the first example;

FIG. 10 is a block diagram illustrating an example of a functional configuration of a RAM and a CPU in a distribution terminal of a distribution system of a second example;

FIG. 11 is a diagram illustrating an example of a content storage unit in the distribution terminal of the distribution system of the second example;

FIG. 12 is a flowchart illustrating an example of transmission limit processing, as an operation of the distribution terminal in the distribution system of the second example;

FIG. 13 is a block diagram illustrating an example of a functional configuration of a RAM and a CPU in a distribution terminal of a distribution system of a third example;

FIG. 14 is a diagram illustrating an example of a content storage unit in the distribution terminal of the distribution system of the third example;

FIG. 15 is a flowchart illustrating an example of transmission limit processing, as an operation of the distribution terminal in the distribution system of the third example;

FIG. 16 is a flowchart illustrating an example of the transmission limit processing, as the operation of the distribution terminal in the distribution system of the third example;

FIG. 17 is a block diagram illustrating an example of a functional configuration of a CPU in a distribution terminal of a distribution system of a fourth example;

FIG. 18 is a flowchart illustrating an example of transmission limit processing, as an operation of the distribution terminal in the distribution system of the fourth example;

FIG. 19 is a flowchart illustrating an example of the transmission limit processing, as the operation of the distribution terminal in the distribution system of the fourth example;

FIG. 20 is a flowchart illustrating an example of the transmission limit processing, as the operation of the distribution terminal in the distribution system of the fourth example;

FIG. 21 is a flowchart illustrating an example of the transmission limit processing, as the operation of the distribution terminal in the distribution system of the fourth example;

FIG. 22 is a block diagram illustrating an example of a functional configuration of a CPU in a distribution terminal of a distribution system of a fifth example;

FIG. 23 is a flowchart illustrating an example of transmission limit processing, as an operation of the distribution terminal in the distribution system of the fifth example;

FIG. 24 is a flowchart illustrating an example of the transmission limit processing, as the operation of the distribution terminal in the distribution system of the fifth example;

FIG. 25 is a flowchart illustrating an example of the transmission limit processing, as the operation of the distribution terminal in the distribution system of the fifth example;

FIG. 26 is a flowchart illustrating an example of the transmission limit processing, as the operation of the distribution terminal in the distribution system of the fifth example;

FIG. 27 is a block diagram illustrating an example of a functional configuration of a CPU in a distribution terminal of a distribution system of a sixth example;

FIG. 28 is a flowchart illustrating an example of an operation of the distribution terminal in the distribution system of the sixth example;

FIG. 29 is a block diagram illustrating an example of a functional configuration of a CPU in a distribution terminal of a distribution system of a seventh example; and

FIG. 30 is a flowchart illustrating an example of an operation of the distribution terminal in the distribution system of the seventh example.

### DESCRIPTION OF EMBODIMENTS

Preferred embodiments of the present invention will be explained with reference to accompanying drawings. Furthermore, the following examples do not limit the disclosed technology. In addition, the following examples may be suitably combined within a range not causing a contradiction.

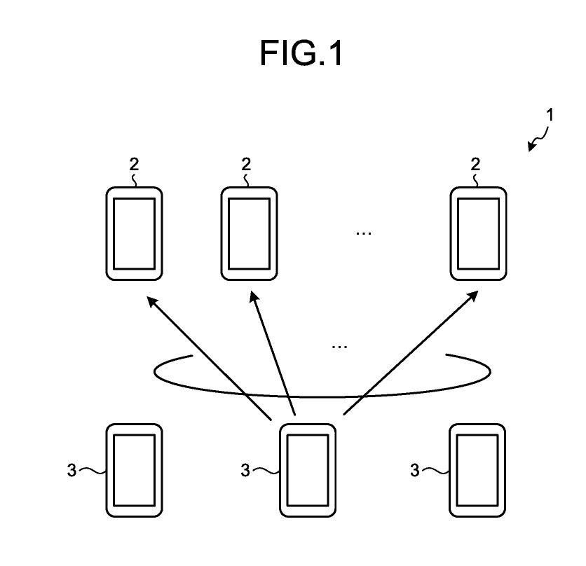

FIG. 1 is a diagram illustrating an example of a distribution system 1 of this example. The distribution system 1 includes a plurality of distribution terminals 2, and a plurality of acquisition terminals 3.

Each of the plurality of distribution terminals 2, for example, is provided in facilities such as a retail premises or an event site. The distribution terminal 2, for example, is a communication device (a distribution device) which stores contents, and distributes the stored contents to the peripheral acquisition terminal 3.

Each of the plurality of acquisition terminals 3, for example, is a communication device (an acquisition device) which receives the contents distributed from the distribution terminal 2, and displays the received contents. A portable terminal such as a smart phone or a tablet is exemplified as the acquisition terminal 3.

A near field communication function such as a WiFi direct function is provided in the distribution terminal 2 and the acquisition terminal 3. The WiFi direct function includes a device discovery function of discovering a device having a WiFi direct function, which exists in a near field communication range, in addition to a wireless communication connection function or an information transmission function between the distribution terminal 2 and the acquisition terminal 3, between the distribution terminals 2, and between the acquisition terminals 3. Further, the WiFi direct function includes a service discovery function of discovering service information provided by the discovered device.

In the distribution system 1 using the WiFi direct function, it is possible for the acquisition terminal 3 to discover the distribution terminal 2 existing in the near field communication range by using a WiFi direct service discovery request message. That is, the acquisition terminal 3 is capable of discovering the distribution terminal 2 existing in the near field communication range, as the discovery of the device. For example, the acquisition terminal 3 transmits the WiFi direct service discovery request message in near field communication, and receives the service discovery response message from the distribution terminal 2, and thus, discovers the distribution terminal 2 existing in the near field communication range. In addition, the acquisition terminal 3 establishes WiFi connection, as wireless communication connection with respect to the discovered distribution terminal 2, and thus, the contents retained by the distribution terminal 2 can be acquired from the discovered distribution terminal 2. The contents, for example, are information contents such as usage guide of facilities such as retail premises or event sites, and advertisement or sales information of the facilities. Accordingly, a user of the acquisition terminal 3 is capable of browsing the contents.

In addition, in the distribution system 1 using the WiFi direct function, the acquisition terminal 3 is capable of acquiring meta-information of the contents from the discovered distribution terminal 2 before the contents are acquired from the discovered distribution terminal 2, when the distribution terminal 2 in the near field communication range is discovered. That is, the acquisition terminal 3 is capable of discovering the meta-information of the contents (the contents-relevant information) retained by the distribution terminal 2, as the discovery of the service information. For example, the distribution terminal 2 distributes the contents-relevant information relevant to the contents by using the WiFi direct service discovery response message. The contents-relevant information is included in the service discovery response message. Examples of the contents-relevant information include a content name, a service name, or the like. The acquisition terminal 3 receives the service discovery response message from the distribution terminal 2, and thus, is capable of acquiring the contents-relevant information from the service discovery response message.

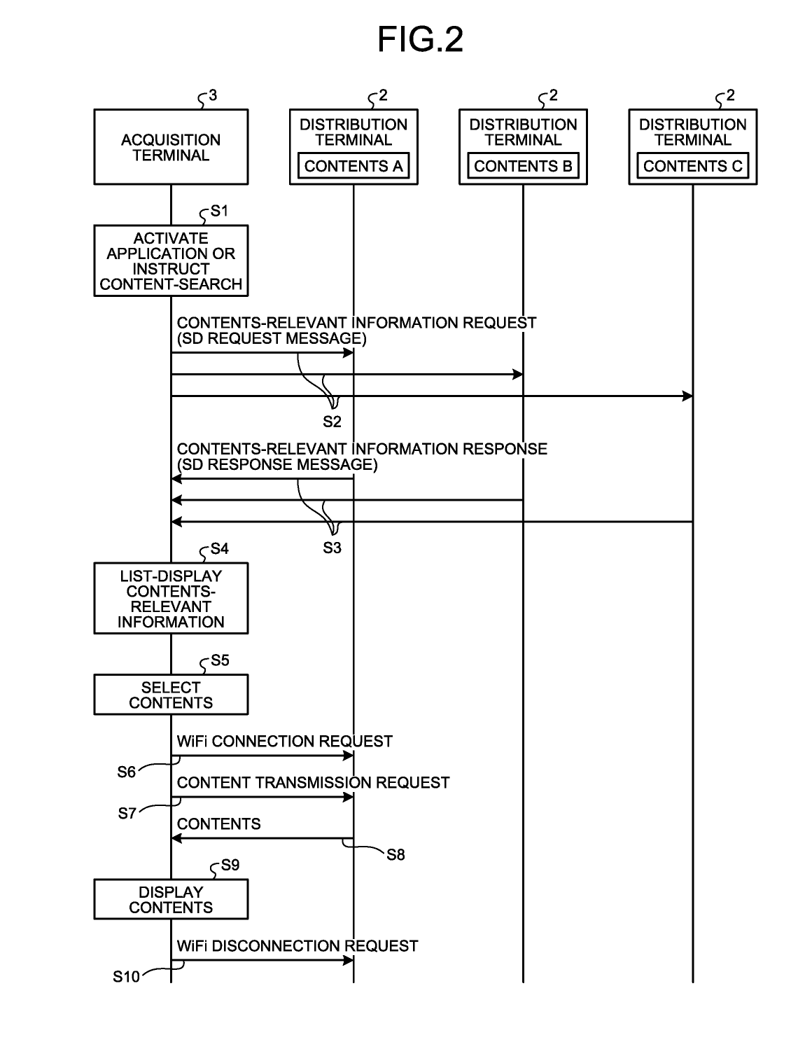

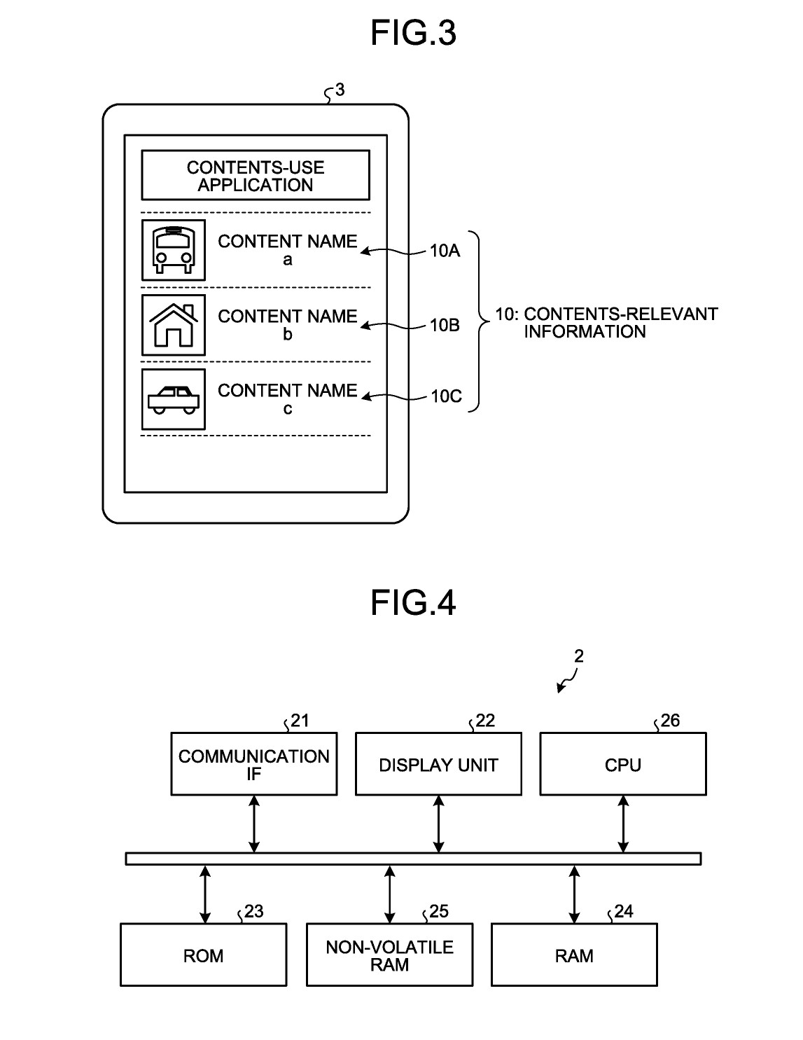

FIG. 2 is a sequence diagram illustrating an example of a distribution service using a WiFi direct function. FIG. 3 is a diagram illustrating an example of contents-relevant information 10 list-displayed on the acquisition terminal 3.

First, as illustrated in FIG. 2, in the acquisition terminal 3, a contents-use application (hereinafter, referred to as an application) is activated according to an operation of the user. Alternatively, in the acquisition terminal 3, a content-search instruction is performed on the application according to the operation of the user (Step S1). At this time, the acquisition terminal 3 transmits a service discovery (SD) request message in near field communication, as a contents-relevant information request for requesting the contents-relevant information (Step S2). The SD request message transmitted from the acquisition terminal 3 is transmitted by a broadcast.

For example, the distribution terminal 2 retaining contents A, the distribution terminal 2 retaining contents B, and the distribution terminal 2 retaining contents C exist in the near field communication range. In this case, three distribution terminals 2 respectively retaining the contents A and B, and C transmit an SD response message in near field communication according to the SD request message transmitted from the acquisition terminal 3, as a contents-relevant information response (Step S3). The contents-relevant information relevant to the contents A and B, and C is included in each of the SD response messages transmitted from three distribution terminals 2.

The acquisition terminal 3 receives the SD response messages transmitted from three distribution terminals 2, and thus, discovers the distribution terminal 2 existing in the near field communication range. At this time, the acquisition terminal 3 acquires the contents-relevant information included in each of three received SD response messages, and list-displays the acquired contents-relevant information (Step S4).

As illustrated in FIG. 3, for example, contents-relevant information items 10A to 10C are list-displayed on the acquisition terminal 3, as the contents-relevant information 10. The contents-relevant information 10A is the contents-relevant information of the contents A, and includes an icon of the contents A, and a content name a, which is a name of the contents A. The contents-relevant information 10B is the contents-relevant information of the contents B, and includes an icon of the contents B, and a content name b, which is a name of the contents B. The contents-relevant information 10C is the contents-relevant information of the contents C, and includes an icon of the contents C, and a content name c, which is a name of the contents C.

The user selects one content name in the content names list-displayed on the acquisition terminal 3. For example, as illustrated in FIG. 2, the user selects the content name of the contents A (Step S5). At this time, the acquisition terminal 3 transmits a WiFi connection request to the distribution terminal 2 retaining the contents A, as a wireless communication connection request for requesting connection of wireless communication (Step S6). The distribution terminal 2 retaining the contents A establishes the WiFi connection according to the WiFi connection request transmitted from the acquisition terminal 3, as the wireless communication connection between the acquisition terminal 3 and the distribution terminal 2 retaining the contents A.

In a case where the WiFi connection is performed between the acquisition terminal 3 and the distribution terminal 2 retaining the contents A, the acquisition terminal 3 transmits a content transmission request for requesting transmission of the contents A to the distribution terminal 2 retaining the contents A (Step S7). The distribution terminal 2 retaining the contents A transmits the contents A according to the content transmission request transmitted from the acquisition terminal 3 (Step S8). The acquisition terminal 3 acquires the contents A from the distribution terminal 2 retaining the contents A, and displays the contents A (Step S9).

For example, the acquisition terminal 3 transmits a WiFi disconnection request to the distribution terminal 2 retaining the contents A, as a wireless communication disconnection request for requesting disconnection of the wireless communication in the connection (Step S10). The distribution terminal 2 retaining the contents A performs the disconnection of the WiFi connection between the acquisition terminal 3 and the distribution terminal 2 retaining the contents A, according to the WiFi disconnection request transmitted from the acquisition terminal 3.

Thus, in the distribution system 1 using the WiFi direct function, the acquisition terminal 3 is capable of acquiring the contents-relevant information from the discovered distribution terminal 2 before the contents are acquired from the distribution terminal 2 discovered in the near field communication range.

In addition, in the distribution system 1 using the WiFi direct function, one distribution terminal 2 retains a plurality of contents different from each other, and thus, is capable of distributing the plurality of contents to each of the acquisition terminals 3.

However, in a case where one distribution terminal 2 simultaneously distributes the contents to the plurality of acquisition terminals 3, a decrease in processing performance is assumed on the distribution terminal 2 side.

Specifically, for example, in a case where one distribution terminal 2 distributes the plurality of contents, a frequency that the content transmission request is transmitted from the plurality of acquisition terminals 3 to one distribution terminal 2 increases, compared to a case where one distribution terminal 2 distributes one content. Accordingly, when one distribution terminal 2 distributes the plurality of contents, an increase in a transmission band is assumed. For this reason, there is a possibility that a throughput for the distribution terminal 2 to transmit the contents per the acquisition terminal 3 decreases. In a case where the throughput decreases, time for transmitting the contents (transmission time) increases. In a case where the transmission time increases, it take time from the request for the contents of the acquisition terminal 3 to the distribution of the contents, and convenience of the user of the acquisition terminal 3 may decrease.

In order to solve the problem, it is desirable to distribute an access from the acquisition terminal 3 to the distribution terminal 2. For example, distribution terminals 2 are provided in the same portion with respect to each of the contents, and thus, the content transmission request transmitted from the acquisition terminal 3 is distributed, and it is possible to prevent an increase in a content transmission amount from one distribution terminal 2 to the acquisition terminal 3. However, the plurality of distribution terminals 2 are provided in the same portion, and thus, there is a demerit that the cost for a device (the distribution terminal 2), management, and the like increases, or an operation labor for the storage of the contents, setting, and the like increases.

In this example, it is possible to prevent a decrease in the throughput for one distribution terminal 2 to distribute the plurality of contents to each of the acquisition terminals 3. An example of this case will be described as a first example.

### [a] First Example

FIG. 4 is a block diagram illustrating an example of a hardware configuration of the distribution terminal 2 in the distribution system 1 of this example. The distribution terminal 2 includes a communication interface (hereinafter, referred to as a communication IF) 21, a display unit 22, a read only memory (ROM) 23, a random access memory (RAM) 24, a non-volatile RAM 25, and a central processing unit (CPU) 26.

The communication IF 21, for example, is an interface which performs communication such as general wireless communication or near field communication

The display unit 22, for example, is an output interface which displays various information items such as contents, icons, or lists. For example, in a case where the display unit 22 is a touch panel display, the display unit 22 has a function of an input interface which receives an operation input from the user, and a function of an output interface which displays various information items described above.

The ROM 23 is an area which stores various information items such as a program. The RAM 24, for example, is a working area or the like, which is used by the CPU 26. The non-volatile RAM 25, for example, is an area which stores various information items such as each downloaded program.

The CPU 26 controls the entire distribution terminal 2. The CPU 26 decompresses the program stored in the ROM 23 on the RAM 24, and executes a processing function by using the program decompressed on the RAM 24 as a process.

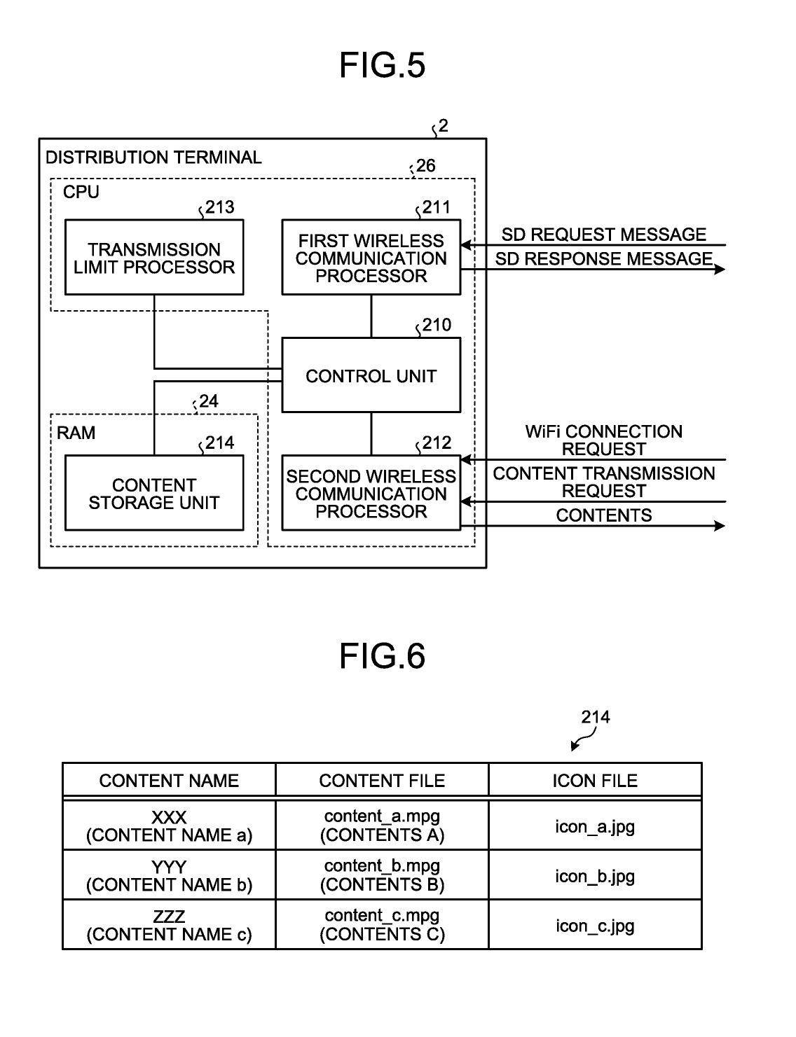

FIG. 5 is a block diagram illustrating an example of a functional configuration of the RAM 24 and the CPU 26 in the distribution terminal 2 of the distribution system 1 of the first example. As illustrated in FIG. 5, the RAM 24 in the distribution terminal 2 is provided with a content storage unit 214. FIG. 6 is a diagram illustrating an example of the content storage unit 214 in the distribution terminal 2 of the distribution system 1 of the first example.

In the distribution system 1 of the first example, the distribution terminal 2 retains the contents A to C described above, as the plurality of contents.

For example, as illustrated in FIG. 6, the content storage unit 214 in the distribution terminal 2 stores the contents A, and the icon and the content name a of the contents A, in association with each other. For example, the content storage unit 214 stores a file of “content_a.mpg” of the contents A, and a file of “icon_a.jpg” of the icon and the content name a of “XXX” of the contents A, in association with each other. In this case, the contents-relevant information 10A illustrated in FIG. 3 includes the icon of the contents A, and the content name a.

In addition, as illustrated in FIG. 6, the content storage unit 214 in the distribution terminal 2 stores the contents B, and the icon and the content name b of the contents B, in association with each other. For example, the content storage unit 214 stores a file of “content_b.mpg” of the contents B, and a file of “icon_b.jpg” of the icon and the content name b of “YYY” of the contents B, in association with each other. In this case, the contents-relevant information 10B illustrated in FIG. 3 includes the icon of the contents B, and the content name b.

In addition, as illustrated in FIG. 6, the content storage unit 214 in the distribution terminal 2 stores the contents C, and the icon and the content name c of the contents C, in association with each other. For example, the content storage unit 214 stores a file of “content_c.mpg” of the contents C, and a file of “icon_c.jpg” of the icon and the content name c of “ZZZ” of the contents C, in association with each other. In this case, the contents-relevant information 10C illustrated in FIG. 3 includes the icon of the contents C, and the content name c.

As illustrated in FIG. 5, the CPU 26 in the distribution terminal 2 is provided with a control unit 210, a first wireless communication processor 211, a second wireless communication processor 212, and a transmission limit processor 213.

In a case where the own terminal exists in the near field communication range, the first wireless communication processor 211, for example, receives the SD request message transmitted from the acquisition terminal 3. When the SD request message is received, the first wireless communication processor 211 reads out the contents-relevant information items 10A to 10C from the content storage unit 214. The first wireless communication processor 211 transmits the SD response message including the contents-relevant information items 10A to 10C in the near field communication, as the contents-relevant information response.

In a case where the WiFi connection request transmitted from the acquisition terminal 3 is received, the second wireless communication processor 212 establishes the WiFi connection according to the WiFi connection request, as the wireless communication connection between the acquisition terminal 3 and the distribution terminal 2. The second wireless communication processor 212 receives the content transmission request transmitted from the acquisition terminal 3. In this case, the second wireless communication processor 212 transmits the contents selected (requested) by the user according to the content transmission request.

The transmission limit processor 213 monitors the first wireless communication processor 211, and counts the number of SD request messages received by the first wireless communication processor 211 for each unit time. The transmission limit processor 213 calculates an average value of the SD request message per unit time, on the basis of the number of SD request messages counted for each unit time. Here, the calculated average value of the SD request message is assumed as the number of acquisitions N. The number of acquisitions N indicates the number of acquisition terminals 3 existing in the near field communication range. The transmission limit processor 213 determines whether or not the number of acquisitions N is greater than an upper limit value Nth. In a case where the number of acquisitions N is not greater than the upper limit value Nth, the transmission limit processor 213 controls the first wireless communication processor 211 such that the contents-relevant information items 10A to 10C are included in the SD response message.

The control unit 210 controls the entire CPU 26.

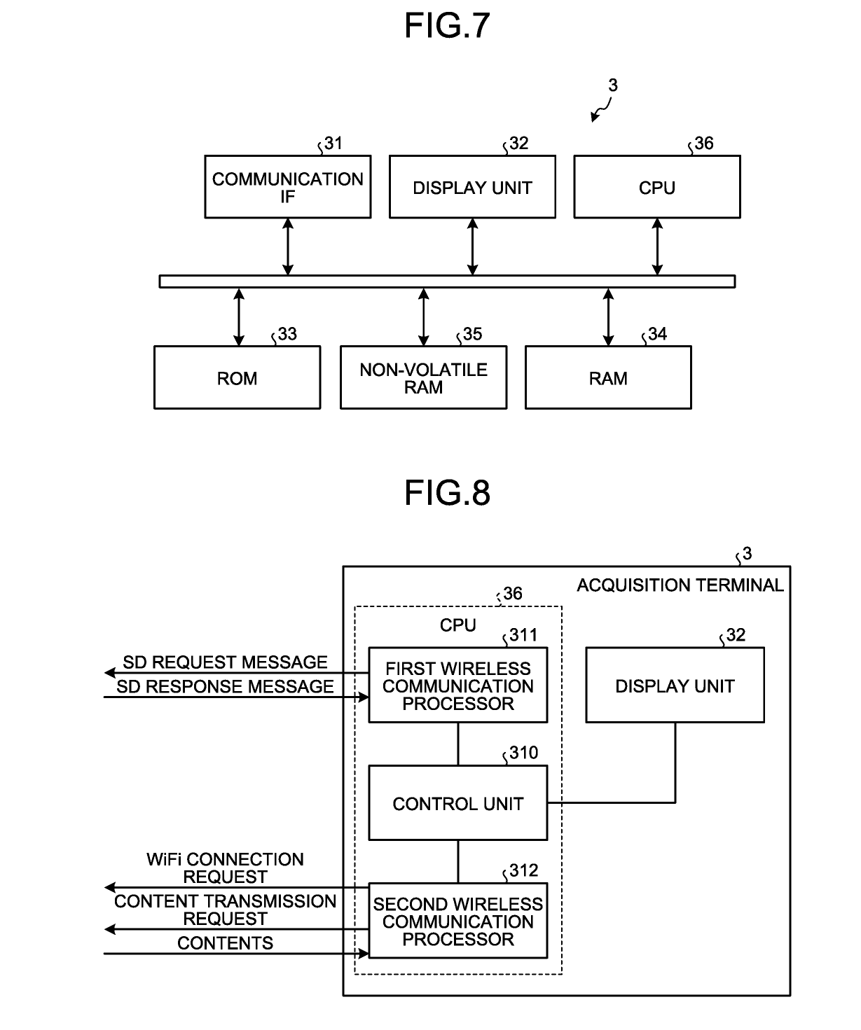

FIG. 7 is a block diagram illustrating an example of a hardware configuration of the acquisition terminal 3 in the distribution system 1 of this example. The acquisition terminal 3 includes a communication interface (hereinafter, referred to as a communication IF) 31, a display unit 32, read only memory (ROM) 33, a random access memory (RAM) 34, a non-volatile RAM 35, and a central processing unit (CPU) 36.

The communication IF 31, for example, is an interface which performs communication such as general wireless communication or near field communication.

The display unit 32, for example, is an output interface which displays various information items such as contents, icons, or lists. For example, in a case where the display unit 32 is a touch panel display, the display unit 32 has a function of an input interface which receives an operation input from the user, and a function of an output interface which displays various information items described above.

The ROM 33 is an area which stores various information items such as a program. The RAM 34, for example, is a working area or the like, which is used by the CPU 36. The non-volatile RAM 35, for example, is an area which stores various information items such as each downloaded program.

The CPU 36 controls the entire acquisition terminal 3. The CPU 36 decompresses the program stored in the ROM 33 on the RAM 34, and executes a processing function by using the program decompressed on the RAM 34 as a process.

FIG. 8 is a block diagram illustrating an example of a functional configuration of the CPU 36 in the acquisition terminal 3 of the distribution system 1 of the first example. The CPU 36 in the acquisition terminal 3 is provided with a control unit 310, a first wireless communication processor 311, and a second wireless communication processor 312.

When the application is activated, or when the content-search instruction is performed on the application, the first wireless communication processor 311 transmits the SD request message in the near field communication, as the contents-relevant information request. The SD request message is transmitted from the acquisition terminal 3 by a broadcast. The first wireless communication processor 311 receives the SD response message transmitted from the distribution terminal 2, and discovers the distribution terminal 2 existing in the near field communication range. When the SD response message is received, the first wireless communication processor 311 acquires the contents-relevant information items 10A to 10C included in the received SD response message.

The second wireless communication processor 312 transmits the WiFi connection request to the distribution terminal 2, as the wireless communication connection request. For example, one contents-relevant information item is selected by the user in the contents-relevant information items 10A to 10C list-displayed on the display unit 32. In this case, the second wireless communication processor 312 transmits the WiFi connection request to the distribution terminal 2. In a case where the WiFi connection is performed between the acquisition terminal 3 and the distribution terminal 2, the second wireless communication processor 312 transmits the content transmission request requesting the contents indicated by the contents-relevant information, which is selected by the user, to the distribution terminal 2, and acquires the contents from the distribution terminal 2.

The control unit 310 controls the entire CPU 36. The control unit 310 list-displays the acquired contents-relevant information on the display unit 32. In addition, the control unit 310 displays the acquired contents on the display unit 32.

In the first example, in the acquisition terminal 3, the first wireless communication processor 311 executes Steps S1 and S2 of FIG. 2, the second wireless communication processor 312 executes Steps S6, S7, and S10 of FIG. 2, and the control unit 310 executes Steps S4, S5, and S9 of FIG. 2. In the distribution terminal 2, the first wireless communication processor 211 executes Step S3 of FIG. 2, and the second wireless communication processor 212 executes Step S8 of FIG. 2.

Further, in the first example, the distribution terminal 2 is capable of avoiding a decrease in the throughput at the time of distributing (transmitting) the plurality of contents to each of the acquisition terminals 3 by the following processing.

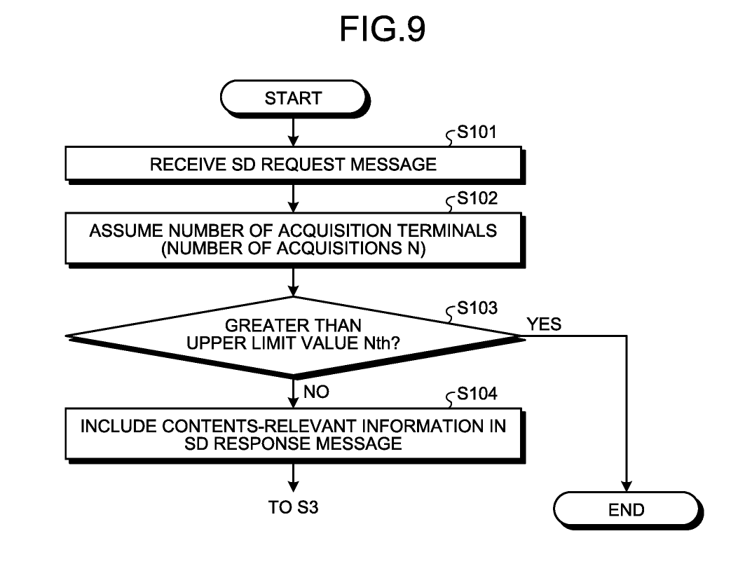

FIG. 9 is a flowchart illustrating an example of transmission limit processing, as the operation of the distribution terminal 2 in the distribution system 1 of the first example.

The first wireless communication processor 211 receives the SD request message transmitted from the acquisition terminal 3 existing in the near field communication range. At this time, the transmission limit processor 213 monitors the first wireless communication processor 211, and counts the number of SD request messages received by the first wireless communication processor 211 for each unit time (Step S101).

Next, the transmission limit processor 213 calculates the average value of the number of SD request messages per unit time, on the basis of the number of SD request messages counted for each unit time. In this case, the transmission limit processor 213 assumes the calculated average value of the number of SD request messages, as the number of acquisition terminals 3 (the number of acquisitions N) (Step S102).

Next, the transmission limit processor 213 determines whether or not the number of acquisitions N is greater than the upper limit value Nth (Step S103).

Here, the number of acquisitions N is not greater than the upper limit value Nth (Step S103: No). In this case, the transmission limit processor 213 controls the first wireless communication processor 211 such that the contents-relevant information items 10A to 10C stored in the content storage unit 214 are included in the SD response message (Step S104). The contents-relevant information items 10A to 10C respectively include the icons and the content names a to c of the contents A to C.

After that, Step S3 and the subsequent steps of FIG. 2 are performed. In this case, the transmission limit processor 213 controls the first wireless communication processor 211 and the second wireless communication processor 212 as follows. In Step S3, the first wireless communication processor 211 transmits the SD response message including the contents-relevant information items 10A to 10C in the near field communication. In Step S6, the second wireless communication processor 212 establishes the WiFi connection according to the WiFi connection request transmitted from the acquisition terminal 3, as the wireless communication connection between the acquisition terminal 3 and the distribution terminal 2. In Step S7, for example, the acquisition terminal 3 transmits the content transmission request for requesting the transmission of the contents A to the distribution terminal 2. In this case, in Step S8, the second wireless communication processor 212 transmits the contents A according to the content transmission request transmitted from the acquisition terminal 3.

On the other hand, the number of acquisitions N is greater than the upper limit value Nth (Step S103: Yes). In this case, the transmission limit processor 213 ends the transmission limit processing without performing the Step S104.

In this case, Step S3 and the subsequent steps of FIG. 2 are not performed. That is, in a case where the number of acquisitions N is greater than upper limit value Nth, the SD response message including the contents-relevant information items 10A to 10C is not transmitted. In the acquisition terminal 3, the SD response message including the contents-relevant information is not received, and thus, it is recognized that there is no distribution terminal 2 distributing the contents in the vicinity of the acquisition terminal 3. Therefore, the contents-relevant information items 10A to 10C are not displayed on the display unit 32 of the acquisition terminal 3. Accordingly, in a case where the number of acquisitions N is greater than the upper limit value Nth, a transmission request of the contents does not occur from the acquisition terminal 3 with respect to the distribution terminal 2, and thus, it is possible to prevent an increase in the content transmission amount from one distribution terminal 2 to the acquisition terminal 3.

As described above, in the distribution system 1 of the first example, the acquisition terminal 3 transmits the contents-relevant information request (SD request message) to the distribution terminal 2 before the wireless communication connection (the WiFi connection) is established. In the distribution terminal 2, the first wireless communication processor 211 transmits the contents-relevant information 10A relevant to the contents A (the SD response message) to the acquisition terminal 3, according to the contents-relevant information request (the SD request message). The second wireless communication processor 212 transmits the contents A to the acquisition terminal 3 after the wireless communication connection (the WiFi connection) is established. The transmission limit processor 213 controls the wireless communication processor (the first wireless communication processor 211 and the second wireless communication processor 212) such that the transmission limit of the contents is performed on the basis of the number of acquisition terminals 3 at the time of receiving the contents-relevant information request (the SD request message). For this reason, in the distribution system 1 of the first example, it is possible to avoid a decrease in the throughput when the one distribution terminal 2 distributes (transmits) the plurality of contents to each of the acquisition terminals 3.

For example, in the distribution terminal 2 of the distribution system 1 of the first example, the transmission limit processor 213 assumes the number of contents-relevant information requests (SD request messages) received per unit time as the number of acquisition terminals 3 (the number of acquisitions N). Here, in a case where the number of acquisitions N is not greater than the upper limit value Nth, the transmission limit processor 213 controls the wireless communication processor (the first wireless communication processor 211 and the second wireless communication processor 212) such that the contents A to C are transmitted to the acquisition terminal 3. On the other hand, in a case where the number of acquisitions N is greater than the upper limit value Nth, the transmission limit processor 213 controls the wireless communication processor (the first wireless communication processor 211 and the second wireless communication processor 212) such that the contents A to C are not transmitted to the acquisition terminal 3, as the transmission limit of the contents. Accordingly, in the distribution system 1 of the first example, in a case where the number of acquisitions N is greater than the upper limit value Nth, the transmission request of the contents does not occur from the acquisition terminal 3 with respect to the distribution terminal 2, and thus, it is possible to prevent an increase in the content transmission amount from one distribution terminal 2 to the acquisition terminal 3. Therefore, in the distribution system 1 of the first example, it is possible to avoid a decrease in the throughput when one distribution terminal 2 distributes (transmits) the plurality of contents to each of the acquisition terminals 3.

In the first example, in a case where the number of acquisitions N is greater than the upper limit value Nth, the distribution terminal 2 does not transmit the SD response message including the contents-relevant information items 10A to 10C. However, the embodiments are not limited thereto. For example, the distribution terminal 2 may change the size of the contents distributed (transmitted) to each of the acquisition terminals 3, according to the number of acquisitions N. An example of this case will be described as a second example. Furthermore, in the second example, the same reference numerals will be applied to the same constituents as those of the first example, and the repeated description of the constituents and the operations will be omitted.

### [b] Second Example

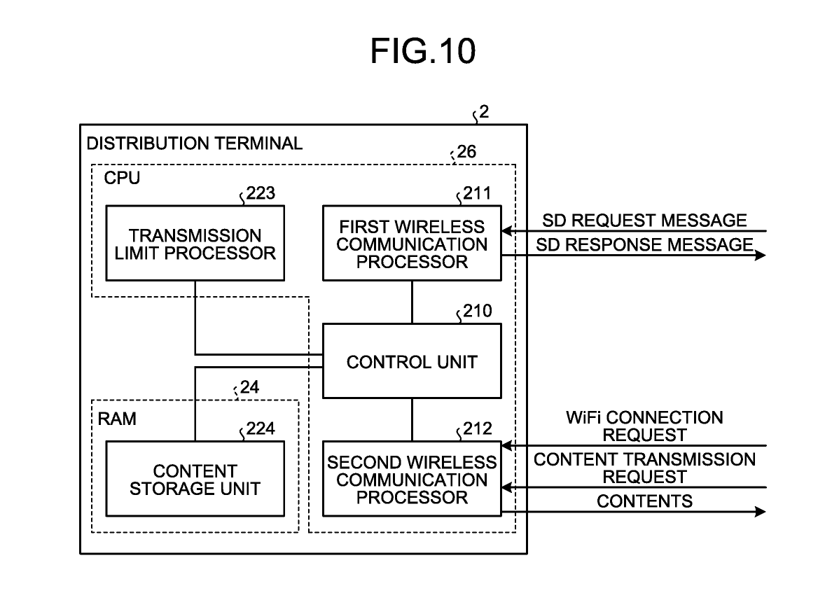

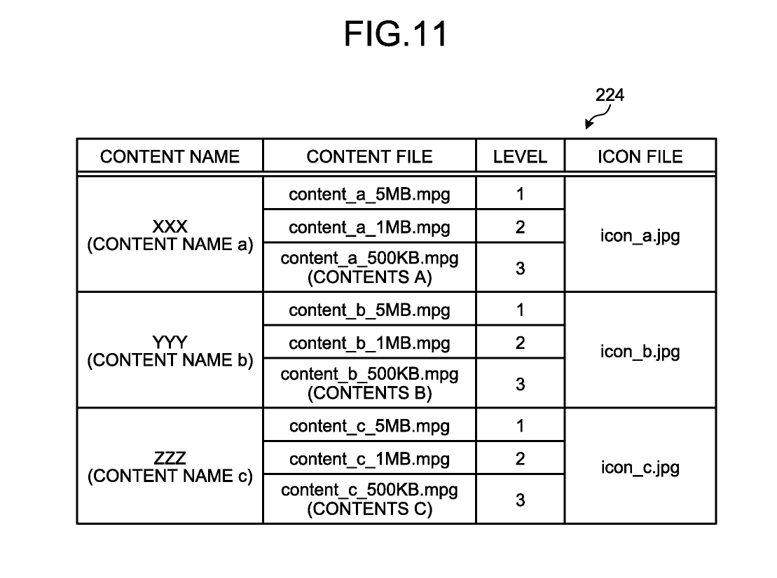

FIG. 10 is a block diagram illustrating an example of a functional configuration of the RAM 24 and the CPU 26 in the distribution terminal 2 of the distribution system 1 of the second example. As illustrated in FIG. 10, the RAM 24 in the distribution terminal 2 is provided with a content storage unit 224. FIG. 11 is a diagram illustrating an example of the content storage unit 224 in the distribution terminal 2 of the distribution system 1 of the second example.

In the distribution system 1 of the second example, the distribution terminal 2 retains the contents A to C as the plurality of contents, as with the first example.

For example, as illustrated in FIG. 11, the content storage unit 224 in the distribution terminal 2 stores the contents A, and the icon and the content name a of the contents A, in association with each other. For example, the contents A are configured of three contents having different sizes. For example, the content storage unit 224 stores a file of “content_a_5 MB.mpg” of the contents A having a size of 5 Mbytes (MB), a level of “1” described below, and a file of “icon_a.jpg” of the icon and the content name a of “XXX” of the contents A, in association with each other. In addition, the content storage unit 224 stores a file of “content_a_1 MB.mpg” of the contents A having a size of 1 MB, a level of “2” described below, and a file of “icon_a.jpg” of the icon and the content name a of “XXX” of the contents A, in association with each other. In addition, the content storage unit 224 stores a file of “content_a_500 KB.mpg” of the contents A having a size of 500 Kbyte (KB), a level of “3” described below, and a file of “icon_a.jpg” of the icon and the content name a of “XXX” of the contents A, in association with each other.

In addition, as illustrated in FIG. 11, the content storage unit 224 in the distribution terminal 2 stores the contents B, and the icon and the content name b of the contents B, in association with each other. For example, the contents B are configured of three contents having different sizes. For example, the content storage unit 224 stores a file of “content_b_5 MB.mpg” of the contents B having a size of 5 Mbytes (MB), a level of “1” described below, and a file of “icon_b.jpg” of the icon and the content name b of “YYY” of the contents B, in association with each other. In addition, the content storage unit 224 stores a file of “content_b_1 MB.mpg” of the contents B having a size of 1 MB, a level of “2” described below, and a file of “icon_b.jpg” of the icon and the content name b of “YYY” of the contents B, in association with each other. In addition, the content storage unit 224 stores a file of “content_b_500 KB.mpg” of the contents B having a size of 500 Kbyte (KB), a level of “3” described below, and a file of “icon_b.jpg” of the icon and the content name b of “YYY” of the contents B, in association with each other.

In addition, as illustrated in FIG. 11, the content storage unit 224 in the distribution terminal 2 stores the contents C, the icon and the content name c of the contents C, in association with each other. For example, the contents C are configured of three contents having different sizes. For example, the content storage unit 224 stores a file of “content_c_5 MB.mpg” of the contents C having a size of 5 Mbytes (MB), a level of “1” described below, and a file of “icon_c.jpg” of the icon and the content name c of “ZZZ” of the contents C, in association with each other. In addition, the content storage unit 224 stores a file of “content_c_1 MB.mpg” of the contents C having a size of 1 MB, a level of “2” described below, a file of “icon_c.jpg” of the icon and the content name c of “ZZZ” of the contents C, in association with each other. In addition, the content storage unit 224 stores a file of “content_c_500 KB.mpg” of the contents C having a size of 500 Kbyte (KB), a level of “3” described below, and a file of “icon_c.jpg” of the icon and the content name c of “ZZZ” of the contents C, in association with each other.

As illustrated in FIG. 10, the CPU 26 in the distribution terminal 2 is provided with the control unit 210, the first wireless communication processor 211, the second wireless communication processor 212, and a transmission limit processor 223.

The transmission limit processor 223 monitors the first wireless communication processor 211, and counts the number of SD request messages received by the first wireless communication processor 211 for each unit time. The transmission limit processor 223 calculates the average value of the SD request message per unit time, on the basis of the number of SD request messages counted for each unit time. Here, the calculated average value of the SD request message is assumed as the number of acquisitions N. The number of acquisitions N indicates the number of acquisition terminals 3 existing in the near field communication range. The transmission limit processor 223 determines the level of the number of acquisitions N.

Here, in a case where the number of acquisitions N is less than the number of settings N1 (N<N1), the transmission limit processor 223 determines the level of the number of acquisitions N as a level of “1”. In addition, the number of acquisitions N is greater than or equal to the number of settings N1, and in a case where the number of acquisitions N is less than or equal to the number of settings N2 greater than the number of settings N1 (N1≤N≤N2), the transmission limit processor 223 determines the level of the number of acquisitions N as a level of “2”. In addition, in a case where the number of acquisitions N is greater than the number of settings N2 (N≤N2), the transmission limit processor 223 determines the level of the number of acquisitions N as a level of “3”. The transmission limit processor 223 selects the contents according to the level from the contents stored in the content storage unit 224.

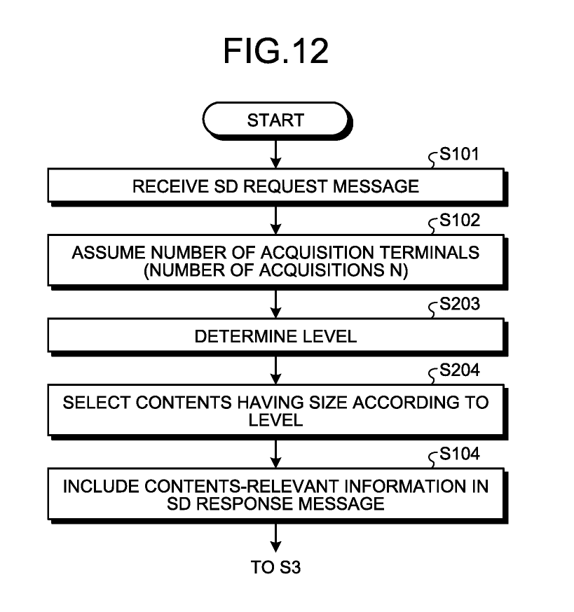

FIG. 12 is a flowchart illustrating an example of transmission limit processing, as the operation of the distribution terminal 2 in the distribution system 1 of the second example.

First, Steps S101 and S102 of the first example are performed. Next, the transmission limit processor 223 determines the level of the number of acquisitions N. For example, the number of acquisitions N is greater than the number of settings N2. In this case, the transmission limit processor 223 determines the level of the number of acquisitions N as a level of “3” (Step S203).

Next, the transmission limit processor 223 selects the contents A to C having a size according to the level of “3”. That is, in three levels of the contents A stored in the content storage unit 224, a file of “content_a_500 KB.mpg” of the contents A having a size of “500 KB” according to the level of “3” is selected. In addition, in three levels of the contents B stored in the content storage unit 224, a file of “content_b_500 KB.mpg” of the contents B having a size of “500 KB” according to the level of “3” is selected. In addition, in three levels of the contents C stored in the content storage unit 224, a file of “content_c_500 KB.mpg” of the contents C having a size of “500 KB” according to the level of “3” is selected (Step S204).

After that, Step S104 of the first example is performed, Step S3 and the subsequent steps of FIG. 2 are performed. In this case, the transmission limit processor 223 controls the first wireless communication processor 211 and the second wireless communication processor 212 as follows. In Step S3, the first wireless communication processor 211 transmits the SD response message including the contents-relevant information items 10A to 10C in the near field communication. In Step S6, the second wireless communication processor 212 establishes the WiFi connection according to the WiFi connection request transmitted from the acquisition terminal 3, as the wireless communication connection between the acquisition terminal 3 and the distribution terminal 2. In Step S7, for example, the acquisition terminal 3 transmits the content transmission request for requesting the transmission of the contents A to the distribution terminal 2. In this case, in Step S8, the second wireless communication processor 212 transmits the contents A having a size of 500 KB, according to the content transmission request transmitted from the acquisition terminal 3.

As described above, in the distribution system 1 of the second example, the transmission limit processor 223 of the distribution terminal 2 assumes the number of contents-relevant information requests (SD request messages) received per unit time as the number of acquisition terminals 3 (the number of acquisitions N). Here, the transmission limit processor 223 controls the wireless communication processor (in this case, the second wireless communication processor 212) such that the contents A to C having a size according to the number of acquisitions N are transmitted to the acquisition terminal 3, as the transmission limit of the contents. Thus, in the distribution system 1 of the second example, the size of the contents A distributed from the distribution terminal 2 decreases as the number of acquisitions N increases, and thus, it is possible to prevent an increase in the content transmission amount from one distribution terminal 2 to the acquisition terminal 3. In addition, in the distribution system 1 of the second example, the size of the contents A distributed from the distribution terminal 2 decreases as the number of acquisitions N increases, but all of the acquisition terminals 3 existing in the vicinity of the distribution terminal 2 are capable of acquiring the contents A distributed from the distribution terminal 2. Therefore, in the distribution system 1 of the second example, it is possible to avoid a decrease in the throughput when one distribution terminal 2 distributes (transmits) the plurality of contents to each of the acquisition terminals 3.

In the first example, in a case where the number of acquisitions N is greater than the upper limit value Nth, the distribution terminal 2 does not transmit the SD response message including the contents-relevant information items 10A to 10C. However, the embodiments are not limited thereto. For example, in a case where the number of acquisitions N is greater than the upper limit value Nth, the distribution terminal 2 may transmit contents other than the contents set in advance in the plurality of contents A to C. An example of this case will be described as a third example. Furthermore, in the third example, the same reference numerals will be applied to the same constituents as those of the first example, and the repeated description of the constituents and the operations will be omitted.

### [c] Third Example

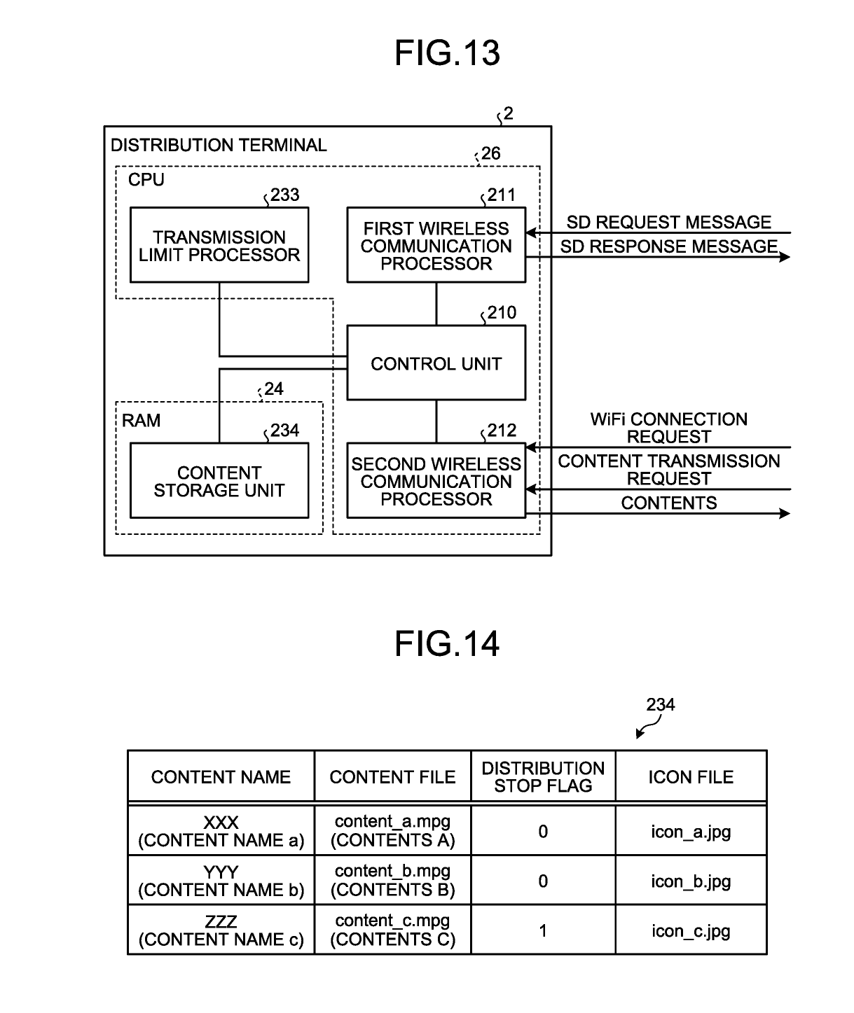

FIG. 13 is a block diagram illustrating an example of a functional configuration of the RAM 24 and the CPU 26 in the distribution terminal 2 of the distribution system 1 of the third example. As illustrated in FIG. 13, the RAM 24 in the distribution terminal 2 is provided with a content storage unit 234. FIG. 14 is a diagram illustrating an example of the content storage unit 234 in the distribution terminal 2 of the distribution system 1 of the third example.

In the distribution system 1 of the third example, the distribution terminal 2 retains the contents A to C as the plurality of contents, as with the first example.

For example, as illustrated in FIG. 14, the content storage unit 234 in the distribution terminal 2 stores the contents A, a distribution stop flag, and the icon and the content name a of the contents A, in association with each other. For example, the content storage unit 234 stores a file of “content_a.mpg” of the contents A, the distribution stop flag of “0”, and a file of “icon_a.jpg” of the icon, and the content name a of “XXX” of the contents A in association with each other. In a case where the distribution stop flag is “0”, there is no limit in the transmission of the contents A.

In addition, as illustrated in FIG. 14, the content storage unit 234 in the distribution terminal 2 stores the contents B, the distribution stop flag, and the icon and the content name b of the contents B, in association with each other. For example, the content storage unit 234 stores a file of “content_b.mpg” of the contents B, the distribution stop flag of “0”, and a file of “icon_b.jpg” of the icon and the content name b of “YYY” of the contents B, in association with each other. In a case where the distribution stop flag is “0”, there is no limit in the transmission of the contents B.

In addition, as illustrated in FIG. 14, the content storage unit 234 in the distribution terminal 2 stores the contents C, the distribution stop flag, and the icon and the content name c of the contents C, in association with each other. For example, the content storage unit 234 stores a file of “content_c.mpg” of the contents C, the distribution stop flag of “1”, and a file of “icon_c.jpg” of the icon and the content name c of “ZZZ” of the contents C, in association with each other. In a case where the distribution stop flag is “1”, there is a limit in the transmission of the contents C. For example, the contents C are contents having the lowest access frequency in the contents A to C.

As illustrated in FIG. 13, the CPU 26 in the distribution terminal 2 is provided with the control unit 210, the first wireless communication processor 211, the second wireless communication processor 212, and a transmission limit processor 233.

The transmission limit processor 233 monitors the first wireless communication processor 211, and counts the number of SD request messages received by the first wireless communication processor 211 for each unit time. The transmission limit processor 233 calculates the average value of the SD request message per unit time, on the basis of the number of SD request messages counted for each unit time. Here, the calculated average value of the SD request message is assumed as the number of acquisitions N. The number of acquisitions N indicates the number of acquisition terminals 3 existing in the near field communication range. The transmission limit processor 233 determines whether or not the number of acquisitions N is greater than the upper limit value Nth.

In a case where the number of acquisitions N is not greater than the upper limit value Nth, the transmission limit processor 233 selects the plurality of contents A to C stored in the content storage unit 234. On the other hand, in a case where the number of acquisitions N is greater than the upper limit value Nth, the transmission limit processor 233 selects the contents A and B other than the contents C in which the distribution stop flag of “1” is set, in the plurality of contents A to C stored in the content storage unit 234.

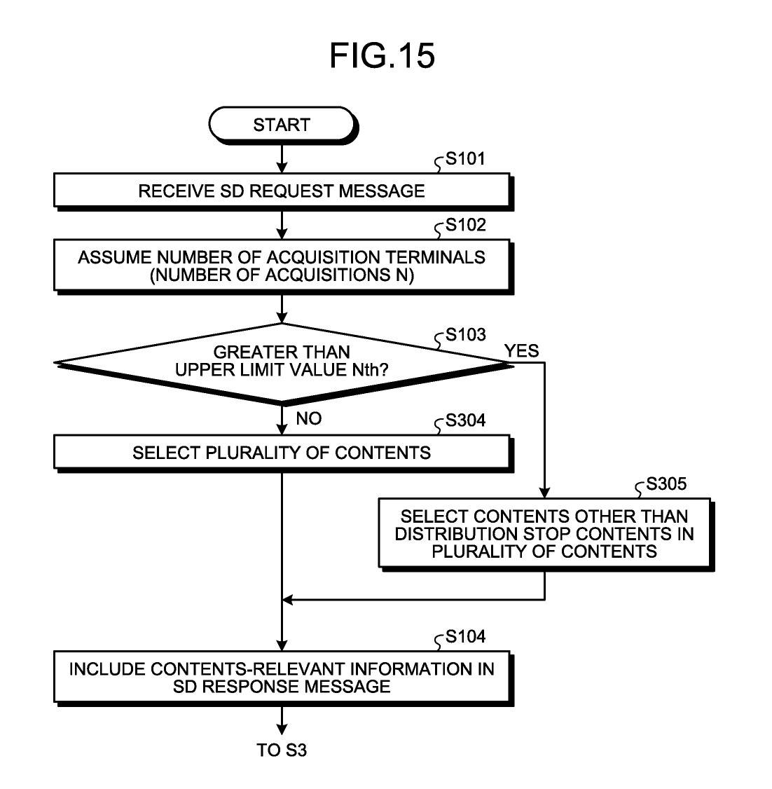

FIG. 15 is a flowchart illustrating an example of transmission limit processing, as the operation of the distribution terminal 2 in the distribution system 1 of the third example.

First, Steps S101 to S103 of the first example are performed. Here, the number of acquisitions N is not greater than the upper limit value Nth (Step S103: No). In this case, the transmission limit processor 233, for example, selects the contents A to C stored in the content storage unit 234 (Step S304).

After that, Step S104 of the first example is performed, and Step S3 and the subsequent steps of FIG. 2 are performed. In this case, the transmission limit processor 233 controls the first wireless communication processor 211 and the second wireless communication processor 212 as follows. In Step S3, the first wireless communication processor 211 transmits the SD response message including the contents-relevant information items 10A to 10C in the near field communication. In Step S6, the second wireless communication processor 212 establishes the WiFi connection according to the WiFi connection request transmitted from the acquisition terminal 3, as the wireless communication connection between the acquisition terminal 3 and the distribution terminal 2. In Step S7, for example, the acquisition terminal 3 transmits the content transmission request for requesting the transmission of the contents A to the distribution terminal 2. In this case, in Step S8, the second wireless communication processor 212 transmits the contents A according to the content transmission request transmitted from the acquisition terminal 3.

On the other hand, the number of acquisitions N is greater than the upper limit value Nth (Step S103: Yes). In this case, the transmission limit processor 233, for example, selects contents A and B other than the contents C in which the distribution stop flag of “1” is set, in contents A to C stored in the content storage unit 234 (Step S305).

After that, Step S104 of the first example is performed, and Step S3 and the subsequent steps of FIG. 2 are performed. In this case, the transmission limit processor 233 controls the first wireless communication processor 211 and the second wireless communication processor 212 as follows. In Step S3, the first wireless communication processor 211 transmits the SD response message including the contents-relevant information items 10A and 10B in the near field communication. In Step S6, the second wireless communication processor 212 establishes the WiFi connection according to the WiFi connection request transmitted from the acquisition terminal 3, as the wireless communication connection between the acquisition terminal 3 and the distribution terminal 2. In Step S7, for example, the acquisition terminal 3 transmits the content transmission request for requesting the transmission of the contents A to the distribution terminal 2. In this case, in Step S8, the second wireless communication processor 212 transmits the contents A according to the content transmission request transmitted from the acquisition terminal 3.

As described above, in the distribution system 1 of the third example, the transmission limit processor 233 of the distribution terminal 2 assumes the number of contents-relevant information requests (SD request messages) received per unit time as the number of acquisition terminals 3 (the number of acquisitions N). Here, in a case where the number of acquisitions N is not greater than the upper limit value Nth, the transmission limit processor 233 controls the wireless communication processor (in this case, the second wireless communication processor 212) such that the plurality of contents A to C are transmitted to the acquisition terminal 3. On the other hand, in a case where the number of acquisitions N is greater than the upper limit value Nth, the transmission limit processor 233 controls the wireless communication processor (in this case, second wireless communication processor 212) such that the contents A and B other than the contents C set in advance in the plurality of contents A to C are transmitted to the acquisition terminal 3, as the transmission limit of the contents. For this reason, in the distribution system 1 of the third example, it is possible to avoid a decrease in the throughput when one distribution terminal 2 distributes (transmits) the plurality of contents to each of the acquisition terminals 3.

For example, in a case where the number of acquisitions N is greater than the upper limit value Nth, the contents-relevant information 10C relevant to contents C is not included in the SD response message. The contents C are contents having the lowest access frequency in the contents A to C. In the acquisition terminal 3, the contents-relevant information 10C is not received, and thus, it is recognized that there is no distribution terminal 2 distributing the contents C in the vicinity of the acquisition terminal 3. Therefore, the contents-relevant information 10C is not displayed on the display unit 32 of the acquisition terminal 3. Accordingly, in the distribution system 1 of the third example, in a case where the number of acquisitions N is greater than the upper limit value Nth, the transmit request of the contents C does not occur from the acquisition terminal 3 with respect to the distribution terminal 2, it is possible to prevent an increase in the content transmission amount from one distribution terminal 2 to the acquisition terminal 3. Therefore, in the distribution system 1 of the third example, it is possible to avoid a decrease in the throughput when one distribution terminal 2 distributes (transmits) the plurality of contents to each of the acquisition terminals 3.

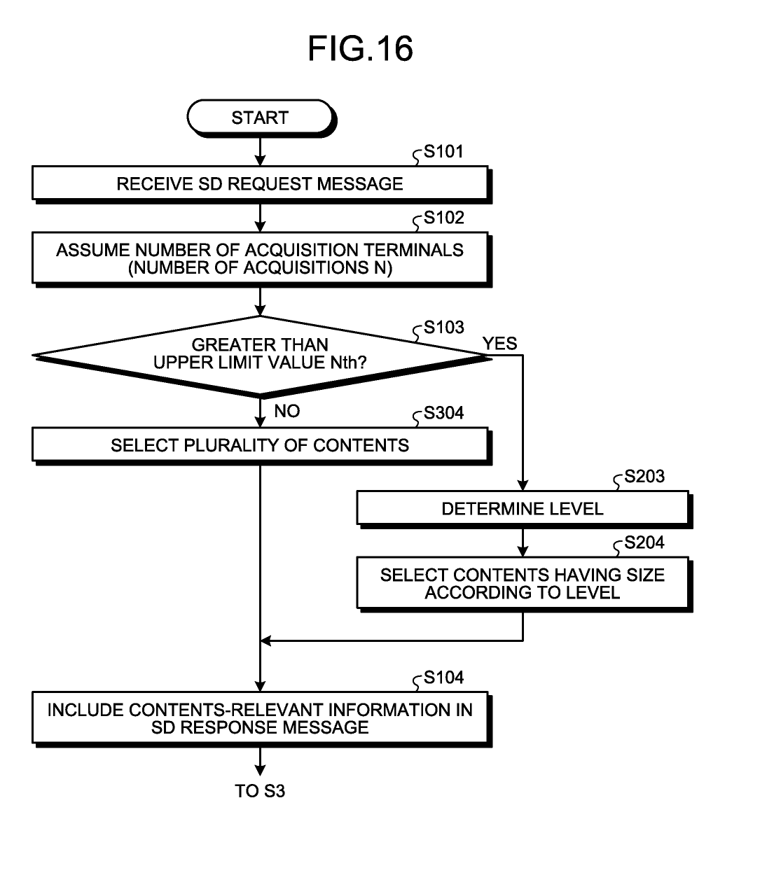

Here, the distribution system 1 of the second example may be applied to the distribution system 1 of the third example. FIG. 16 is a flowchart illustrating an example of transmission limit processing, as the operation of the distribution terminal 2 in the distribution system 1 of the third example.

First, Steps S101 and S102 of the second example and the third example are performed. Here, in a case where the number of acquisitions N is not greater than the upper limit value Nth (Step S103: No), Step S304 of the third example is performed. After that, Step S104 of the third example is performed, and Step S3 and the subsequent steps of FIG. 2 are performed.

On the other hand, in a case where the number of acquisitions N is greater than the upper limit value Nth (Step S103: Yes), Steps S203 and S204 of the second example are performed. After that, Step S104 of the second example and the third example is performed, and Step S3 and the subsequent steps of FIG. 2 are performed.

As described above, in a case where the distribution system 1 of the second example is applied to the distribution system 1 of the third example, the transmission limit processor 233 of the distribution terminal 2 assumes the number of contents-relevant information requests (SD request messages) received per unit time as the number of acquisition terminals 3 (the number of acquisitions N). Here, in a case where the number of acquisitions N is not greater than the upper limit value Nth, the transmission limit processor 233 controls the wireless communication processor (the first wireless communication processor 211 and the second wireless communication processor 212) such that the contents A to C are transmitted to the acquisition terminal 3. On the other hand, in a case where the number of acquisitions N is greater than the upper limit value Nth, the transmission limit processor 233 controls the wireless communication processor (in this case, the second wireless communication processor 212) such that the contents A to C having a size according to the number of acquisitions N are transmitted to the acquisition terminal 3, as the transmission limit of the contents. Thus, in the distribution system 1 of the third example, in a case where the distribution system 1 of the second example is applied, the size of the contents A distributed from the distribution terminal 2 decreases as the number of acquisitions N increases when the number of acquisitions N is greater than the upper limit value Nth, and thus, it is possible to prevent an increase in the content transmission amount from one distribution terminal 2 to the acquisition terminal 3. Therefore, in the distribution system 1 of the third example, even in a case where the distribution system 1 of the second example is applied, it is possible to avoid a decrease in the throughput when one distribution terminal 2 distributes (transmits) the plurality of contents to each of the acquisition terminals 3.

Furthermore, a case where the distribution system 1 of the second example is applied to the distribution system 1 of the third example has been described, but the embodiments are not limited thereto. For example, the same applies to a case where the distribution system 1 of the second example is applied to the distribution system 1 of the first example. That is, in a case where the number of acquisitions N is greater than the upper limit value Nth (Step S103 of FIG. 9: Yes), Steps S203 and S204 of the second example are performed.

In the first example to the third example, the distribution terminal 2 assumes the number of discovery request messages received per unit time as the number of acquisition terminals 3 (the number of acquisitions N). However, the embodiments are not limited thereto. For example, the distribution terminal 2 may measure the transmission amount of the contents currently transmitted to the plurality of acquisition terminals 3 as the number of acquisitions at the time of receiving the discovery request message. An example of this case will be described as a fourth example. Furthermore, in the fourth example, the same reference numerals will be applied to the same constituents as those of the first example to the third example, and the repeated description of the constituents and the operations will be omitted.

### [d] Fourth Example

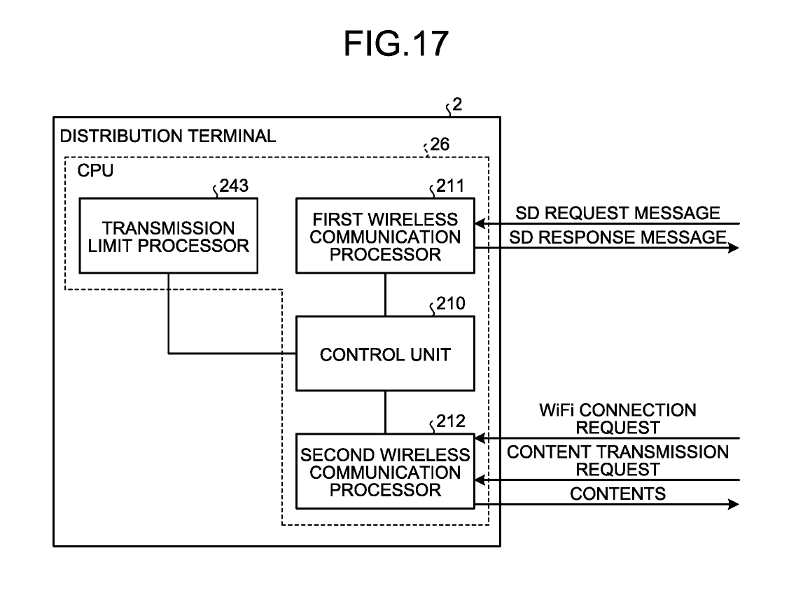

FIG. 17 is a block diagram illustrating an example of a functional configuration of the CPU 26 in the distribution terminal 2 of the distribution system 1 of the fourth example. As illustrated in FIG. 17, the CPU 26 in the distribution terminal 2 is provided with the control unit 210, the first wireless communication processor 211, the second wireless communication processor 212, and a transmission limit processor 243.

The transmission limit processor 243 monitors the first wireless communication processor 211 and the second wireless communication processor 212. The transmission limit processor 243 measures the transmission amount of the contents currently transmitted to the plurality of acquisition terminals 3 by the second wireless communication processor 212 when the discovery request message is received by the first wireless communication processor 211, as the number of acquisitions N. In a case where the number of acquisitions N is measured, the transmission limit processor 243 is capable of avoiding a decrease in the throughput by the following processing. For example, in the distribution system 1 of the fourth example, it is possible to avoid a decrease in the throughput by applying the distribution systems 1 of the first example to the third example.

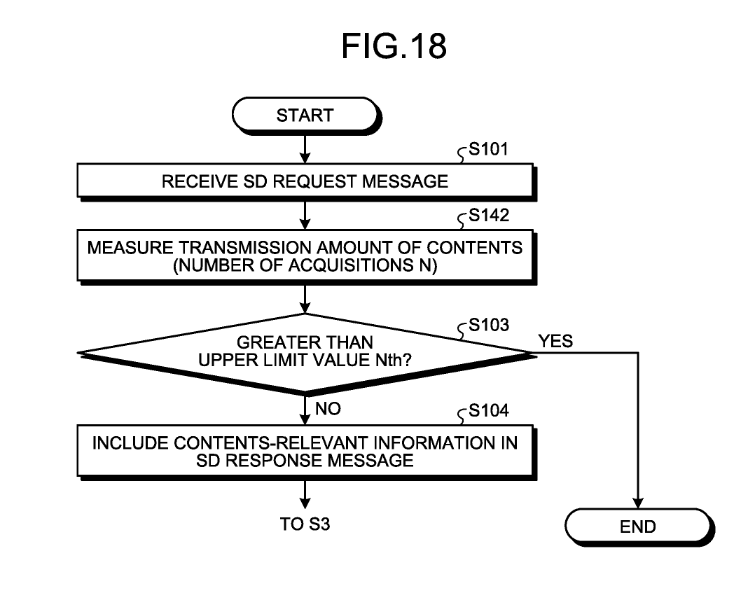

First, a case where the distribution system 1 of the first example is applied as the distribution system 1 of the fourth example has been described. In this case, the RAM 24 in the distribution terminal 2 is provided with the content storage unit 214 of the first example. FIG. 18 is a flowchart illustrating an example of transmission limit processing, as the operation of the distribution terminal 2 in the distribution system 1 of the fourth example.

First, Step S101 of the first example is performed. At this time, the transmission limit processor 243 measures the transmission amount of the contents currently transmitted to the plurality of acquisition terminals 3 by the second wireless communication processor 212, as the number of acquisitions N (Step S142). Here, in a case where the number of acquisitions N is not greater than the upper limit value Nth (Step S103: No), Step S104 of the first example is performed. After that, Step S3 and the subsequent steps of FIG. 2 are performed. On the other hand, the number of acquisitions N is greater than the upper limit value Nth (Step S103: Yes). In this case, the transmission limit processor 243 ends the transmission limit processing without performing Step S104.

As described above, in a case where the distribution system 1 of the first example is applied as the distribution system 1 of the fourth example, the transmission limit processor 243 of the distribution terminal 2 measures the transmission amount of the contents currently transmitted to the plurality of acquisition terminals 3 at the time of receiving the contents-relevant information request (the SD request message), as the number of acquisitions N. Here, in a case where the number of acquisitions N is not greater than the upper limit value Nth, the transmission limit processor 243 controls the wireless communication processor (the first wireless communication processor 211 and the second wireless communication processor 212) such that the contents A to C are transmitted to the acquisition terminal 3. On the other hand, in a case where the number of acquisitions N is greater than the upper limit value Nth, the transmission limit processor 243 controls the wireless communication processor (the first wireless communication processor 211 and the second wireless communication processor 212) such that the contents A to C are not transmitted to the acquisition terminal 3, as the transmission limit of the contents. Thus, in a case where the distribution system 1 of the first example is applied as the distribution system 1 of the fourth example, it is possible to avoid a decrease in the throughput when one distribution terminal 2 distributes (transmits) the plurality of contents to each of the acquisition terminals 3, as with the first example.

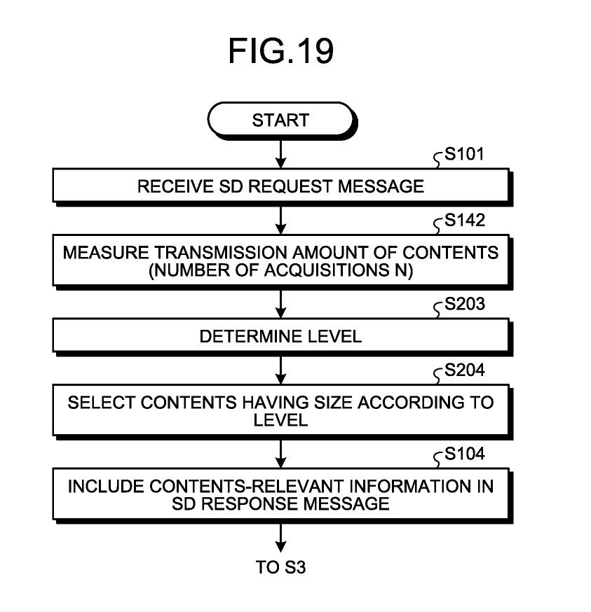

Next, a case where the distribution system 1 of the second example is applied as the distribution system 1 of the fourth example will be described. In this case, the RAM 24 in the distribution terminal 2 is provided with the content storage unit 224 of the second example. FIG. 19 is a flowchart illustrating an example of transmission limit processing, as the operation of the distribution terminal 2 in the distribution system 1 of the fourth example.

First, Steps S101 of the second example, and Step S142 of the fourth example are performed. Next, the transmission limit processor 243 determines the level of the number of acquisitions N. For example, the number of acquisitions N is greater than the number of settings N2. In this case, the transmission limit processor 243 determines the level of the number of acquisitions N as a level of “3” (Step S203). Next, Step S204 of the second example is performed. That is, the transmission limit processor 243 selects the contents A to C having a size according to the level of “3”. After that, Step S104 of the second example is performed, and Step S3 and the subsequent steps of FIG. 2 are performed.

As described above, in a case where the distribution system 1 of the second example is applied as the distribution system 1 of the fourth example, the transmission limit processor 243 of the distribution terminal 2 measures the transmission amount of the contents currently transmitted to the plurality of acquisition terminals 3 at the time of receiving the contents-relevant information request (the SD request message), as the number of acquisitions N. Here, the transmission limit processor 243 controls the wireless communication processor (in this case, the second wireless communication processor 212) such that the contents A to C having a size according to the number of acquisitions N are transmitted to the acquisition terminal 3, as the transmission limit of the contents. Thus, in a case where the distribution system 1 of the second example is applied as the distribution system 1 of the fourth example, it is possible to avoid a decrease in the throughput when one distribution terminal 2 distributes (transmits) the plurality of contents to each of the acquisition terminals 3, as with the second example.

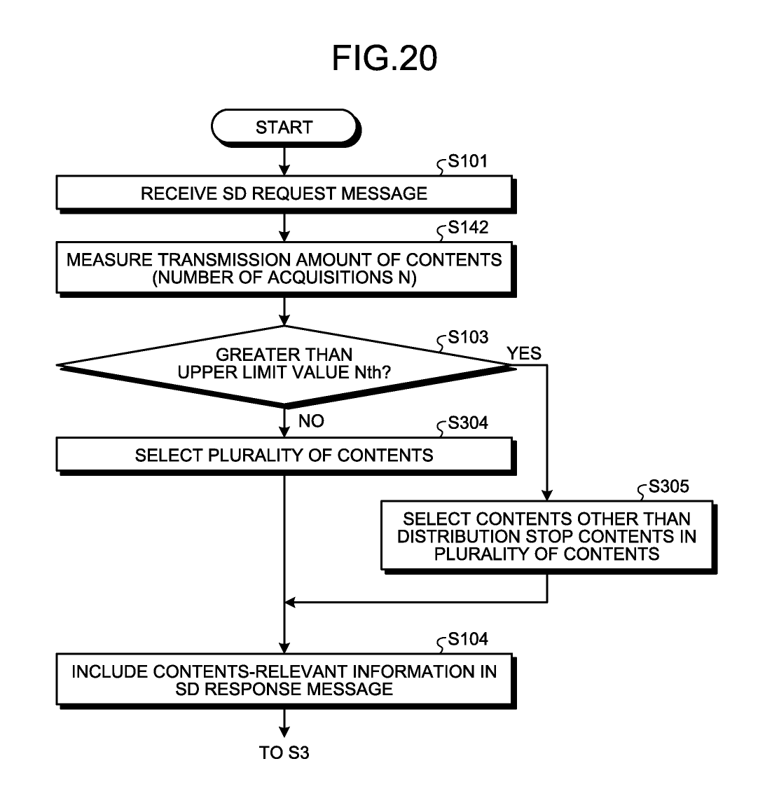

Next, a case where the distribution system 1 of the third example is applied as the distribution system 1 of the fourth example will be described. The RAM 24 in the distribution terminal 2 is provided with the content storage unit 234 of the third example. FIG. 20 is a flowchart illustrating an example of transmission limit processing, as the operation of the distribution terminal 2 in the distribution system 1 of the fourth example.

First, Step S101 of the third example, and Step S142 of the fourth example are performed. Here, in a case where the number of acquisitions N is not greater than the upper limit value Nth (Step S103: No), Step S304 of the third example is performed. After that, Step S104 of the third example is performed, and Step S3 and the subsequent steps of FIG. 2 are performed. On the other hand, in a case where the number of acquisitions N is greater than the upper limit value Nth (Step S103: Yes), Step S305 is performed. After that, Step S104 of the third example is performed, and Step S3 and the subsequent steps of FIG. 2 are performed.

As described above, in a case where the distribution system 1 of the third example is applied as the distribution system 1 of the fourth example, the transmission limit processor 243 of the distribution terminal 2 measures the transmission amount of the contents currently transmitted to the plurality of acquisition terminals 3 at the time of receiving the contents-relevant information request (the SD request message), as the number of acquisitions N. Here, in a case where the number of acquisitions N is not greater than the upper limit value Nth, the transmission limit processor 243 controls the wireless communication processor (in this case, the second wireless communication processor 212) such that the plurality of contents A to C are transmitted to the acquisition terminal 3. On the other hand, in a case where the number of acquisitions N is greater than the upper limit value Nth, the transmission limit processor 243 controls the wireless communication processor (in this case, the second wireless communication processor 212) such that the contents A and B other than the contents C set in advance in the plurality of contents A to C, are transmitted to the acquisition terminal 3, as the transmission limit of the contents. Thus, in a case where the distribution system 1 of the third example is applied as the distribution system 1 of the fourth example, it is possible to avoid a decrease in the throughput when one distribution terminal 2 distributes (transmits) the plurality of contents to each of the acquisition terminals 3, as with the third example.

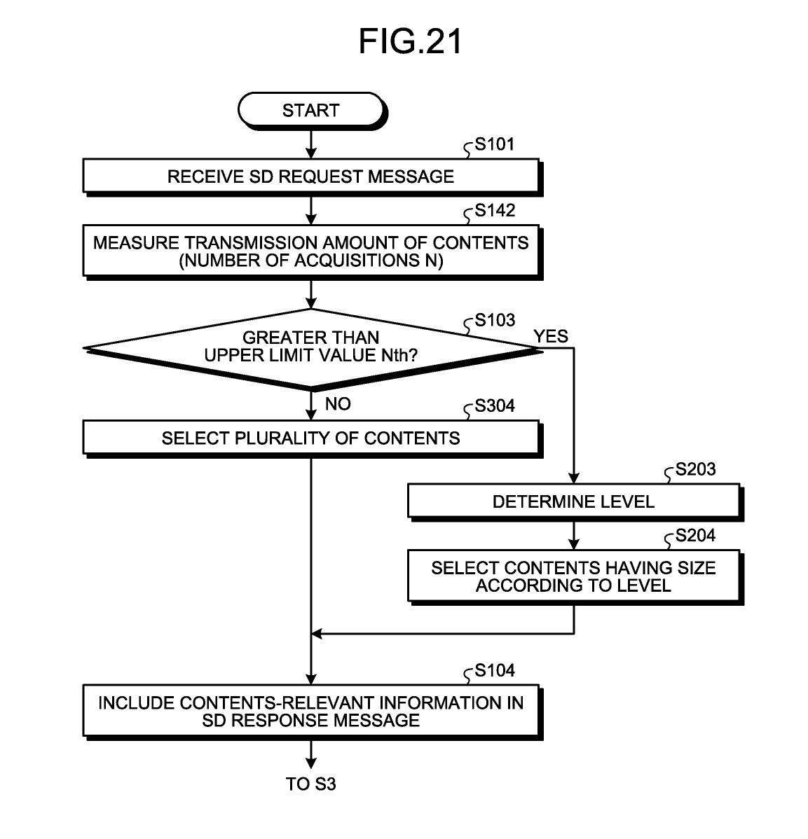

Next, a case where the distribution systems 1 of the second example and the third example are applied as the distribution system 1 of the fourth example will be described. In this case, the RAM 24 in the distribution terminal 2 is provided with the content storage unit 224 of the second example. FIG. 21 is a flowchart illustrating an example of transmission limit processing, as the operation of the distribution terminal 2 in the distribution system 1 of the fourth example.

First, Steps S101 of the second example and the third example, and Step S142 of the fourth example are performed. Here, in a case where the number of acquisitions N is not greater than the upper limit value Nth (Step S103: No), Step S304 of the third example is performed. After that, Step S104 of the second example and the third example is performed, and Step S3 and the subsequent steps of FIG. 2 are performed. On the other hand, in a case where the number of acquisitions N is greater than the upper limit value Nth (Step S103: Yes), Steps S203 and S204 of the second example are performed. After that, Step S104 of the second example and the third example is performed, and Step S3 and the subsequent steps of FIG. 2 are performed.

As described above, in a case where the distribution systems 1 of the second example and the third example are applied as the distribution system 1 of the fourth example, the transmission limit processor 243 of the distribution terminal 2 measures the transmission amount of the contents currently transmitted to the plurality of acquisition terminals 3 at the time of receiving the contents-relevant information request (the SD request message), as the number of acquisitions N. Here, in a case where the number of acquisitions N is not greater than the upper limit value Nth, the transmission limit processor 243 controls the wireless communication processor (the first wireless communication processor 211 and the second wireless communication processor 212) such that the contents A to C are transmitted to the acquisition terminal 3. On the other hand, in a case where the number of acquisitions N is greater than the upper limit value Nth, the transmission limit processor 243 controls the wireless communication processor (in this case, the second wireless communication processor 212) such that the contents A to C having a size according to the number of acquisitions N are transmitted to the acquisition terminal 3, as the transmission limit of the contents. Thus, in a case where the distribution systems 1 of the second example and the third example are applied as the distribution system 1 of the fourth example, it is possible to avoid a decrease in the throughput when one distribution terminal 2 distributes (transmits) the plurality of contents to each of the acquisition terminals 3, as with the second example and the third example.

In the fourth example, the distribution terminal 2 measures the transmission amount of the contents currently transmitted to the plurality of acquisition terminals 3 at the time of receiving the discovery request message, as the number of acquisitions N. However, the embodiments are not limited thereto. For example, the distribution terminal 2 may measure the number of acquisition terminals 3 subjected to the WiFi connection with respect to the own terminal at the time of receiving the discovery request message, as the number of acquisitions. An example of this case will be described as a fifth example. Furthermore, in the fifth example, the same reference numerals will be applied to the same constituents as those of the fourth example, and the repeated description of the constituents and the operations will be omitted.

### [e] Fifth Example

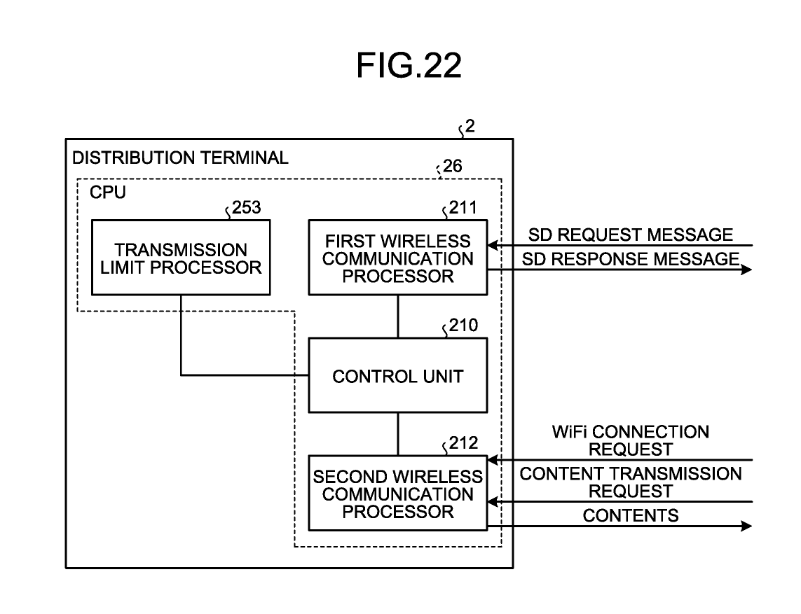

FIG. 22 is a block diagram illustrating an example of a functional configuration of the CPU 26 in the distribution terminal 2 of the distribution system 1 of the fifth example. As illustrated in FIG. 22, the CPU 26 in the distribution terminal 2 is provided with the control unit 210, the first wireless communication processor 211, the second wireless communication processor 212, and a transmission limit processor 253.

The transmission limit processor 253 monitors the first wireless communication processor 211 and the second wireless communication processor 212. The transmission limit processor 253 measures the number of acquisition terminals 3 subjected to the WiFi connection with respect to the second wireless communication processor 212 when the discovery request message is received by the first wireless communication processor 211, as the number of acquisitions N. In a case where the number of acquisitions N is measured, the transmission limit processor 253 is capable of avoiding a decrease in the throughput by the following processing. For example, in the distribution system 1 of the fifth example, it is possible to avoid a decrease in the throughput by applying the distribution systems 1 of the first example to the third example.

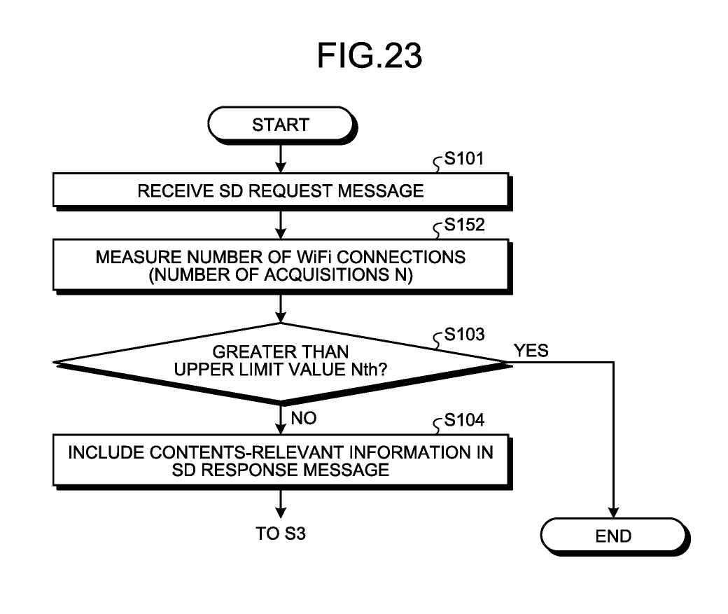

First, a case where the distribution system 1 of the first example is applied as the distribution system 1 of the fifth example will be described. In this case, the RAM 24 in the distribution terminal 2 is provided with the content storage unit 214 of the first example. FIG. 23 is a flowchart illustrating an example of transmission limit processing, as the operation of the distribution terminal 2 in the distribution system 1 of the fifth example.

First, Step S101 of the first example is performed. At this time, the transmission limit processor 253 measures the number of acquisition terminals 3 subjected to the WiFi connection with respect to the second wireless communication processor 212, as the number of acquisitions N (Step S152). Here, in a case where the number of acquisitions N is not greater than the upper limit value Nth (Step S103: No), Step S104 of the first example is performed. After that, Step S3 and the subsequent steps of FIG. 2 are performed. On the other hand, the number of acquisitions N is greater than the upper limit value Nth (Step S103: Yes). In this case, the transmission limit processor 253 ends the transmission limit processing without performing Step S104.

As described above, in a case where the distribution system 1 of the first example is applied as the distribution system 1 of the fifth example, the transmission limit processor 253 of the distribution terminal 2 measures the number of acquisition terminals 3 subjected to the wireless communication connection (the WiFi connection) with respect to the wireless communication processor (in this case, the second wireless communication processor 212) at the time of receiving the contents-relevant information request (the SD request message), as the number of acquisitions N. Here, in a case where the number of acquisitions N is not greater than the upper limit value Nth, the transmission limit processor 253 controls the wireless communication processor (the first wireless communication processor 211 and the second wireless communication processor 212) such that the contents A to C are transmitted to the acquisition terminal 3. On the other hand, in a case where the number of acquisitions N is greater than the upper limit value Nth, the transmission limit processor 253 controls the wireless communication processor (the first wireless communication processor 211 and the second wireless communication processor 212) such that the contents A to C are not transmitted to the acquisition terminal 3, as the transmission limit of the contents. Thus, in a case where the distribution system 1 of the first example is applied as the distribution system 1 of the fifth example, it is possible to avoid a decrease in the throughput when one distribution terminal 2 distributes (transmits) the plurality of contents to the each of the acquisition terminals 3, as with the first example.

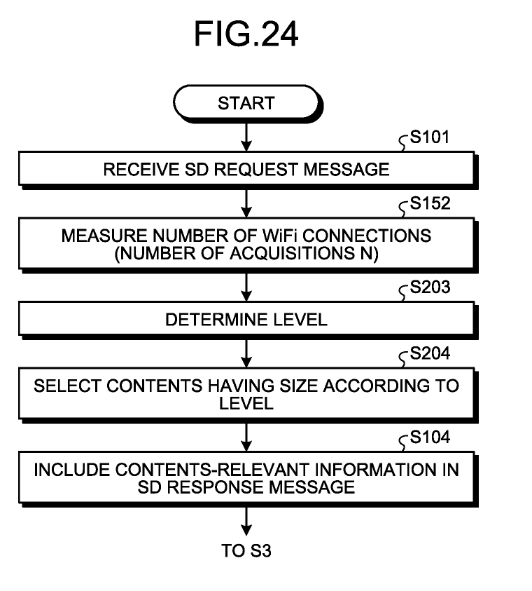

Next, a case where the distribution system 1 of the second example is applied as the distribution system 1 of the fifth example will be described. In this case, the RAM 24 in the distribution terminal 2 is provided with the content storage unit 224 of the second example. FIG. 24 is a flowchart illustrating an example of transmission limit processing, as the operation of the distribution terminal 2 in the distribution system 1 of the fifth example.

First, Step S101 of the second example, and Step S152 of the fifth example are performed. Next, Steps S203 and S204 of the second example are performed. After that, Step S104 of the second example is performed, and Step S3 and the subsequent steps of FIG. 2 are performed.

As described above, in a case where the distribution system 1 of the second example is applied as the distribution system 1 of the fifth example, the transmission limit processor 253 of the distribution terminal 2 measures the number of acquisition terminals 3 subjected to the wireless communication connection (the WiFi connection) with respect to the wireless communication processor (in this case, the second wireless communication processor 212) at the time of receiving the contents-relevant information request (the SD request message), as the number of acquisitions N. Here, the transmission limit processor 253 controls the wireless communication processor (in this case, the second wireless communication processor 212) such that contents A to C having a size according to the number of acquisitions N are transmitted to the acquisition terminal 3, as the transmission limit of the contents. Thus, in a case where the distribution system 1 of the second example is applied as the distribution system 1 of the fifth example, it is possible to avoid a decrease in the throughput when one distribution terminal 2 distributes (transmits) the plurality of contents to each of the acquisition terminals 3, as with the second example.

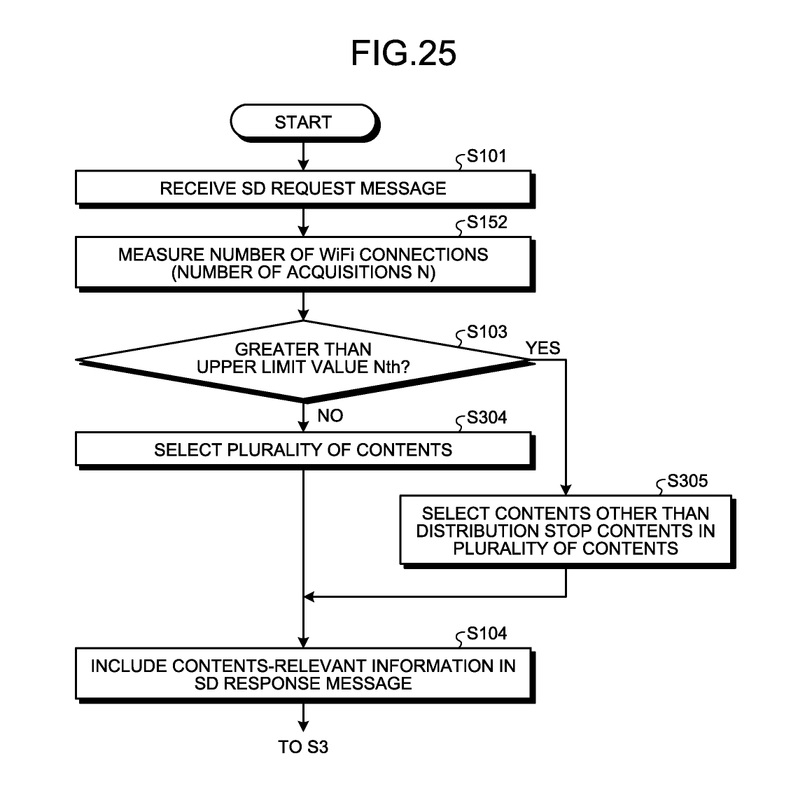

Next, a case where the distribution system 1 of the third example is applied as the distribution system 1 of the fifth example will be described. The RAM 24 in the distribution terminal 2 is provided with the content storage unit 234 of the third example. FIG. 25 is a flowchart illustrating an example of transmission limit processing, as the operation of the distribution terminal 2 in the distribution system 1 of the fifth example.

First, Step S101 of the third example, and Step S152 of the fifth example are performed. Here, in a case where the number of acquisitions N is not greater than the upper limit value Nth (Step S103: No), Step S304 of the third example is performed. After that, Step S104 of the third example is performed, and Step S3 and the subsequent steps of FIG. 2 are performed. On the other hand, in a case where the number of acquisitions N is greater than the upper limit value Nth (Step S103: Yes), Step S305 is performed. After that, Step S104 of the third example is performed, and Step S3 and the subsequent steps of FIG. 2 are performed.

As described above, in a case where the distribution system 1 of the third example is applied as the distribution system 1 of the fifth example, the transmission limit processor 253 of the distribution terminal 2 measures the number of acquisition terminals 3 subjected to the wireless communication connection (the WiFi connection) with respect to the wireless communication processor (in this case, the second wireless communication processor 212) at the time of receiving the contents-relevant information request (the SD request message), as the number of acquisitions N. Here, in a case where the number of acquisitions N is not greater than the upper limit value Nth, the transmission limit processor 253 controls the wireless communication processor (in this case, the second wireless communication processor 212) such that the plurality of contents A to C are transmitted to the acquisition terminal 3. On the other hand, in a case where the number of acquisitions N is greater than the upper limit value Nth, the transmission limit processor 253 controls the wireless communication processor (in this case, the second wireless communication processor 212) such that the contents A and B other than the contents C set in advance in the plurality of contents A to C are transmitted to the acquisition terminal 3, as the transmission limit of the contents. Thus, in a case where the distribution system 1 of the third example is applied as the distribution system 1 of the fifth example, it is possible to avoid a decrease in the throughput when one distribution terminal 2 distributes (transmits) the plurality of contents to each of the acquisition terminals 3, as with the third example.

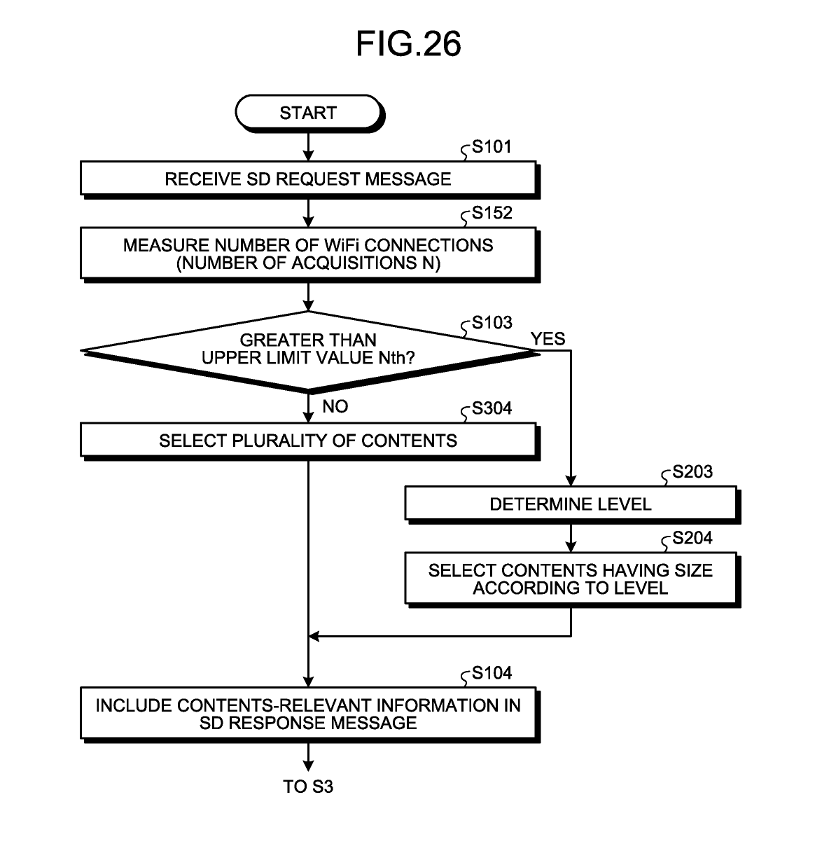

Next, a case where the distribution systems 1 of the second example and the third example are applied as the distribution system 1 of the fifth example will be described. In this case, the RAM 24 in the distribution terminal 2 is provided with the content storage unit 224 of the second example. FIG. 26 is a flowchart illustrating an example of transmission limit processing, as the operation of the distribution terminal 2 in the distribution system 1 of the fifth example.

First, Step S101 of the second example and the third example, and Step S152 of the fifth example are performed. Here, in a case where the number of acquisitions N is not greater than the upper limit value Nth (Step S103: No), Step S304 of the third example is performed. After that, Step S104 of the second example and the third example is performed, and Step S3 and the subsequent steps of FIG. 2 are performed. On the other hand, in a case where the number of acquisitions N is greater than the upper limit value Nth (Step S103: Yes), Steps S203 and S204 of the second example are performed. After that, Step S104 of the second example and the third example is performed, and Step S3 and the subsequent steps of FIG. 2 are performed.

As described above, in a case where the distribution systems 1 of the second example and the third example are applied as the distribution system 1 of the fifth example, the transmission limit processor 253 of the distribution terminal 2 measures the number of acquisition terminals 3 subjected to the wireless communication connection (the WiFi connection) with respect to the wireless communication processor (in this case, the second wireless communication processor 212) at the time of receiving the contents-relevant information request (the SD request message), as the number of acquisitions N. Here, in a case where the number of acquisitions N is not greater than the upper limit value Nth, the transmission limit processor 253 controls the wireless communication processor (the first wireless communication processor 211 and the second wireless communication processor 212) such that the contents A to C are transmitted to the acquisition terminal 3. On the other hand, in a case where the number of acquisitions N is greater than the upper limit value Nth, the transmission limit processor 253 controls the wireless communication processor (in this case, the second wireless communication processor 212) such that the contents A to C having a size according to the number of acquisitions N are transmitted to the acquisition terminal 3, as the transmission limit of the contents. Thus, in a case where the distribution systems 1 of the second example and the third example are applied as the distribution system 1 of the fifth example, it is possible to avoid a decrease in the throughput when one distribution terminal 2 distributes (transmits) the plurality of contents to each of the acquisition terminals 3, as with the third example.

In the first example to the fifth example, in a case where the number of acquisitions N is greater than the upper limit value Nth, the distribution terminal 2 performs the transmission limit of the contents. However, the embodiments are not limited thereto. For example, the distribution terminal 2 may release the transmission limit of the contents according to the transmission amount of the contents currently transmitted to the plurality of acquisition terminals 3. An example of this case will be described as a sixth example. Furthermore, in the sixth example, the same reference numerals will be applied to the same constituents as those of the first example to the fifth example, and the repeated description of the constituents and the operations will be omitted.

### [f] Sixth Example

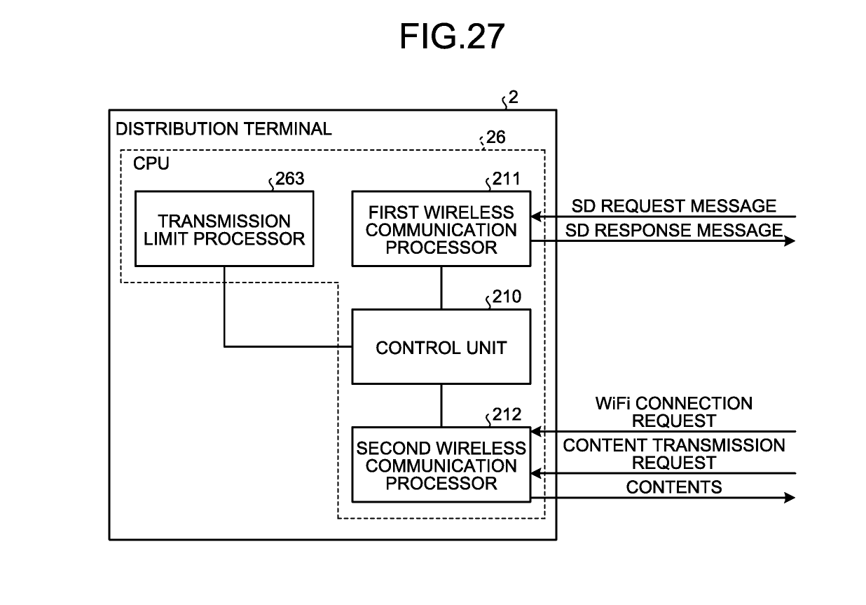

FIG. 27 is a block diagram illustrating an example of a functional configuration of the CPU 26 in the distribution terminal 2 of the distribution system 1 of the sixth example. As illustrated in FIG. 27, the CPU 26 in the distribution terminal 2 is provided with the control unit 210, the first wireless communication processor 211, the second wireless communication processor 212, and a transmission limit processor 263.

The transmission limit processor 263 measures a transmission amount T of the contents currently transmitted to the plurality of acquisition terminals 3 for each fixed period. In a case where the transmission amount T is measured, the transmission limit processor 263 is capable of releasing the transmission limit of the contents by the following processing.

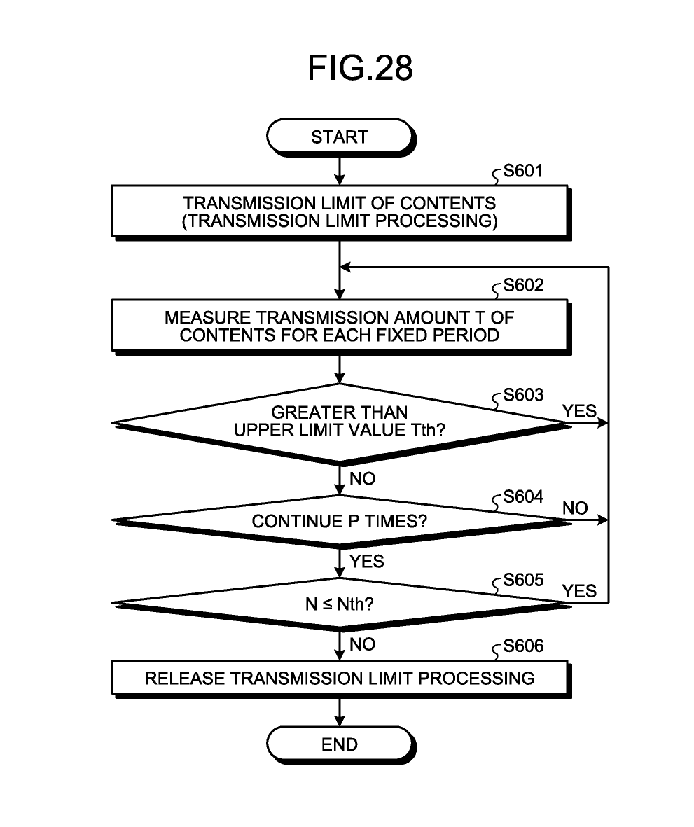

FIG. 28 is a flowchart illustrating an example of the operation of the distribution terminal 2 in the distribution system 1 of the sixth example.

First, the transmission limit processor 263 performs the transmission limit processing as the transmission limit of the contents (Step S601). For example, the transmission limit processing of any one of the first example to the fifth example is performed.

Next, the transmission limit processor 263 measures the transmission amount T of the contents currently transmitted to the plurality of acquisition terminals 3 for each fixed period (Step S602). The transmission limit processor 263 determines whether or not the transmission amount T is greater than a setting value Tth (Step S603). The setting value Tth may be the same as the upper limit value Nth of the fourth example.

Here, the transmission amount T is greater than the setting value Tth (Step S603: Yes). In this case, Step S602 is performed. That is, the transmission limit processor 263 continues the transmission limit processing.

On the other hand, the transmission amount T is not greater than the setting value Tth (Step S603: No). In this case, the transmission limit processor 263 determines whether or not a state where the transmission amount T is not greater than the setting value Tth is continued P times (Step S604). Furthermore, there is a possibility that the transmission amount T is greater than the setting value Tth immediately after the transmission limit processing is released, and thus, the determination of Step S604 is one of the conditions for releasing the transmission limit processing. In Step S604, for example, in a case where a fixed period is set to one cycle, and P is set to 3, the transmission limit processor 263 determines whether or not the state where the transmission amount T is not greater than the setting value Tth is continued three cycles.

Here, the state where the transmission amount T is not greater than the setting value Tth is not continued P times (Step S604: No). In this case, Step S602 is performed. That is, the transmission limit processor 263 continues the transmission limit processing.

On the other hand, the state where the transmission amount T is not greater than the setting value Tth is continued P times (Step S604: Yes). In this case, the transmission limit processor 263 determines whether or not the number of acquisitions N when the first wireless communication processor 211 receives the SD request message is greater than the upper limit value Nth (Step S605). Furthermore, there is a possibility that the number of acquisitions N is greater than the upper limit value Nth immediately after the content transmission limit processing is released, and the transmission amount T is greater than the setting value Tth, and thus, the determination of Step S605 is one of the conditions for releasing the transmission limit processing.

Here, the number of acquisitions N is greater than the upper limit value Nth (Step S605: Yes). In this case, Step S602 is performed. That is, the transmission limit processor 263 continues the transmission limit processing.

On the other hand, the number of acquisitions N is not greater than the upper limit value Nth (Step S605: No). In this case, the transmission limit processor 263 releases the transmission limit processing (Step S606). For example, Step S104 of the transmission limit processing of any one of the first example to the fifth example is performed when the first wireless communication processor 211 receives the SD request message, as the release of the transmission limit processing. After that, Step S3 and the subsequent steps of FIG. 2 are performed.

As described above, in the distribution terminal 2 of the distribution system 1 of the sixth example, the transmission limit processor 263 measures the transmission amount T of the contents currently transmitted to the plurality of acquisition terminals 3 for each fixed period. Here, when the transmission limit of the contents is performed with respect to the wireless communication processor (the first wireless communication processor 211 and the second wireless communication processor 212), the transmission amount T is greater than the setting value Tth. In this case, the transmission limit processor 263 continues the transmission limit processing, as the transmission limit of the contents. On the other hand, when the transmission limit of the contents is performed with respect to the wireless communication processor (the first wireless communication processor 211 and the second wireless communication processor 212), the transmission amount T is not greater than the setting value Tth. In this case, the transmission limit processor 263 releases the transmission limit of the contents (the transmission limit processing). Thus, in the distribution system 1 of the sixth example, it is possible to release the transmission limit of the contents according to the transmission amount of the contents currently transmitted to the plurality of acquisition terminals 3.

In the sixth example, the distribution terminal 2 releases the transmission limit of the contents, according to the transmission amount of the contents currently transmitted to the plurality of acquisition terminals 3. However, the embodiments are not limited thereto. For example, the distribution terminal 2 may release transmission limit of the contents according to the number of acquisition terminals 3 subjected to the WiFi connection with respect to the own terminal. An example of this case will be described as a seventh example. Furthermore, in the seventh example, the same reference numerals will be applied to the same constituents as those of the sixth example, and the repeated description of the constituents and the operations will be omitted.

### [g] Seventh Example

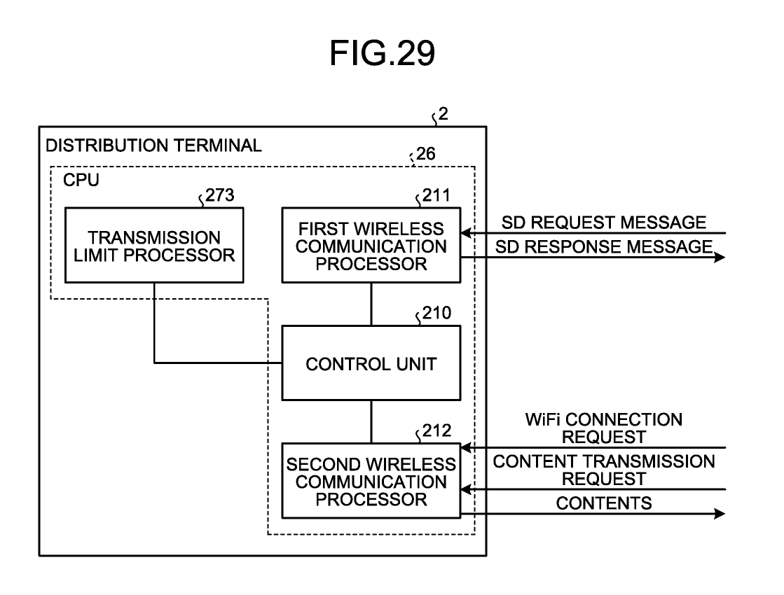

FIG. 29 is a block diagram illustrating an example of a functional configuration of the CPU 26 in the distribution terminal 2 of the distribution system 1 of the seventh example. As illustrated in FIG. 29, the CPU 26 in the distribution terminal 2 is provided with the control unit 210, the first wireless communication processor 211, the second wireless communication processor 212, and a transmission limit processor 273.

The transmission limit processor 273 measures the number of acquisition terminals 3 subjected to the WiFi connection with respect to the own terminal for each fixed period, as the number of connections W. In a case where the number of connections W is measured, the transmission limit processor 273 is capable of releasing the transmission limit of the contents by the following processing.

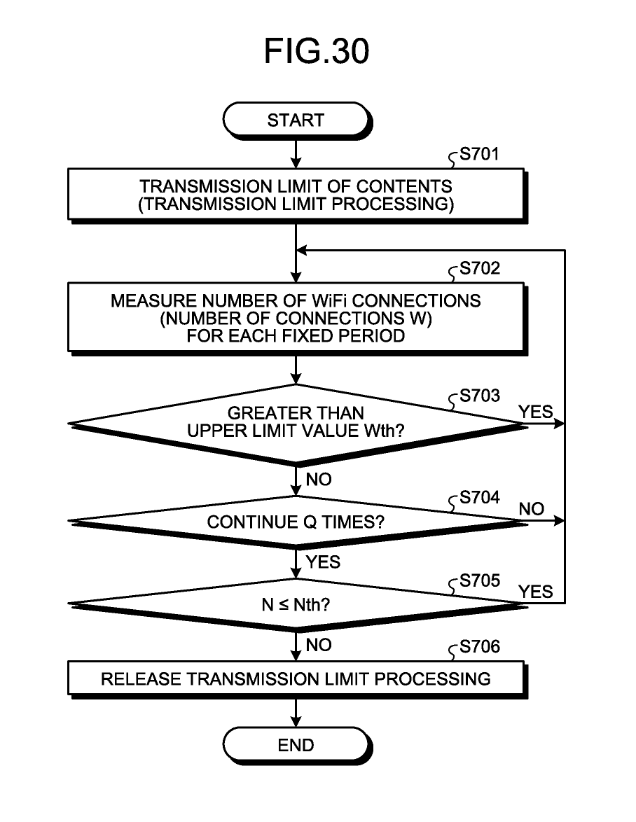

FIG. 30 is a flowchart illustrating an example of the operation of the distribution terminal 2 in the distribution system 1 of the seventh example.

First, the transmission limit processor 273 performs the transmission limit processing as the transmission limit of the contents (Step S701). For example, the transmission limit processing of any one of the first example to the fifth example is performed.

Next, the transmission limit processor 273 measures the number of acquisition terminals 3 subjected to the WiFi connection with respect to the own terminal for each fixed period, as the number of connections W (Step S702). The transmission limit processor 273 determines whether or not the number of connections W is greater than a setting value Wth (Step S703). The setting value Wth may be the same as the upper limit value Nth of the fifth example.

Here, the number of connections W is greater than the setting value Wth (Step S703: Yes). In this case, Step S702 is performed. That is, the transmission limit processor 273 continues the transmission limit processing.

On the other hand, the number of connections W is not greater than the setting value Wth (Step S703: No). In this case, the transmission limit processor 273 determines whether or not a state where the number of connections W is not greater than the setting value Wth is continued Q times (Step S704). Furthermore, there is a possibility that the number of connections W is greater than the setting value Wth immediately after the transmission limit processing is released, and thus, the determination of Step S704 is one of the conditions for releasing the transmission limit processing. In Step S704, for example, in a case where a fixed period is set to one cycle, and Q is set to 3, the transmission limit processor 273 determines whether or not the state where the number of connections W is not greater than the setting value Wth is continued three cycles.

Here, the state where the number of connections W is not greater than the setting value Wth is not continued Q times (Step S704: No). In this case, Step S702 is performed. That is, the transmission limit processor 273 continues the transmission limit processing.

On the other hand, the state where the number of connections W is not greater than the setting value Wth is continued Q times (Step S704: Yes). In this case, the transmission limit processor 273 determines whether or not the number of acquisitions N when the first wireless communication processor 211 receives the SD request message is greater than the upper limit value Nth (Step S705). Furthermore, there is a possibility that the number of acquisitions N is greater than the upper limit value Nth immediately after the content transmission limit processing is released, and the number of connections W is greater than the setting value Wth, and thus, the determination of Step S705 is one of the conditions for releasing the transmission limit processing.

Here, the number of acquisitions N is greater than the upper limit value Nth (Step S705: Yes). In this case, Step S702 is performed. That is, the transmission limit processor 273 continues the transmission limit processing.

On the other hand, the number of acquisitions N is not greater than the upper limit value Nth (Step S705: No). In this case, the transmission limit processor 273 releases the transmission limit processing (Step S706). For example, when the first wireless communication processor 211 receives the SD request message, Step S104 of the transmission limit processing of any one of the first example to the fifth example is performed, as the release of the transmission limit processing. After that, Step S3 and the subsequent steps of FIG. 2 are performed.

As described above, in the distribution terminal 2 of the distribution system 1 of the seventh example, the transmission limit processor 273 measures the number of acquisition terminals 3 (the number of connections W) subjected to the wireless communication connection (the WiFi connection) with respect to the own terminal for each fixed period. Here, when the transmission limit of the contents is performed with respect to the wireless communication processor (the first wireless communication processor 211 and the second wireless communication processor 212), the number of connections W is greater than the setting value Wth. In this case, the transmission limit processor 273 continues the transmission limit processing, as the transmission limit of the contents. On the other hand, when the transmission limit of the contents is performed with respect to the wireless communication processor (the first wireless communication processor 211 and the second wireless communication processor 212), the number of connections W is not greater than the setting value Wth. In this case, the transmission limit processor 273 releases the transmission limit of the contents (the transmission limit processing). Thus, in the distribution system 1 of the seventh example, it is possible to release the transmission limit of the contents according to the number of acquisition terminals 3 subjected to the WiFi connection with respect to the own terminal.

### Other Examples

Each constituent of each unit illustrated in the first example to the seventh example may be physically configured differently from the drawings. That is, a specific aspect of distribution and integration of each of the units is not limited to that illustrated, and all or a part thereof may be configured by being functionally or physically distributed or integrated in arbitrary unit, according to various loads, usage conditions, or the like.

Further, all or any part of various processing performed in each of the devices may be executed on a central processing unit (CPU) (or a micro computer such as a micro processing unit (MPU) or a micro controller unit (MCU)). In addition, all or any part of various processing may be executed on a program, which is analyzed and executed by the CPU (or the micro computer such as the MPU or the MCU), or on hardware of wired logic.

An area storing various information items, for example, may be configured of a read only memory (ROM) or a random access memory (RAM) such as synchronous dynamic random access memory (SDRAM), magnetoresistive random access memory (MRAM), and non-volatile random access memory (NVRAM).

In one aspect, it is possible to avoid a decrease in the throughput when one distribution terminal distributes (transmits) the plurality of contents to each of the acquisition terminals.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distribution terminal, comprising:
a communication unit that receives a request transmitted from an acquisition terminal before wireless communication connection is established, and transmits contents to the acquisition terminal after the wireless communication connection is established; and
a processor that controls the communication unit such that transmission limit of the contents is performed based on a number of acquisition terminals when the request is received.

2. The distribution terminal according to claim 1,
wherein the processor
assumes a number of requests received per unit time, as the number of acquisition terminals, and
controls the communication unit such that the transmission limit of the contents is performed based on a number of acquisitions indicating the number of acquisition terminals.

3. The distribution terminal according to claim 1,
wherein the processor
measures a transmission amount of the contents being transmitted to a plurality of acquisition terminals when the request is received, as a number of acquisitions, and
controls the communication unit such that the transmission limit of the contents is performed based on the number of acquisitions.

4. The distribution terminal according to claim 1,
wherein the processor
measures a number of acquisition terminals which are subjected to wireless communication connection with respect to the distribution terminal when the request is received, as a number of acquisitions, and
controls the communication unit such that the transmission limit of the contents is performed based on the number of acquisitions.

5. The distribution terminal according to claim 2,
wherein the processor
controls the communication unit such that the contents are transmitted to the acquisition terminal, in a case in which the number of acquisitions is not greater than an upper limit value, and
controls the communication unit such that the contents are not transmitted to the acquisition terminal, as the transmission limit of the contents, in a case in which the number of acquisitions is greater than the upper limit value.

6. The distribution terminal according to claim 3,
wherein the processor
controls the communication unit such that the contents are transmitted to the acquisition terminal, in a case in which the number of acquisitions is not greater than an upper limit value, and
controls the communication unit such that the contents are not transmitted to the acquisition terminal, as the transmission limit of the contents, in a case in which the number of acquisitions is greater than the upper limit value.

7. The distribution terminal according to claim 4,
wherein the processor
controls the communication unit such that the contents are transmitted to the acquisition terminal, in a case in which the number of acquisitions is not greater than an upper limit value, and
controls the communication unit such that the contents are not transmitted to the acquisition terminal, as the transmission limit of the contents, in a case in which the number of acquisitions is greater than the upper limit value.

8. The distribution terminal according to claim 2,
wherein the processor controls the communication unit such that the contents having a size according to the number of acquisitions are transmitted to the acquisition terminal, as the transmission limit of the contents.

9. The distribution terminal according to claim 3,
wherein the processor controls the communication unit such that the contents having a size according to the number of acquisitions are transmitted to the acquisition terminal, as the transmission limit of the contents.

10. The distribution terminal according to claim 4,
wherein the processor controls the communication unit such that the contents having a size according to the number of acquisitions are transmitted to the acquisition terminal, as the transmission limit of the contents.

11. The distribution terminal according to claim 2,
wherein the processor
controls the communication unit such that a plurality of contents are transmitted to the acquisition terminal, in a case in which the number of acquisitions is not greater than an upper limit value, and
controls the communication unit such that contents other than contents set in advance in the plurality of contents are transmitted to the acquisition terminal, as the transmission limit of the contents, in a case in which the number of acquisitions is greater than the upper limit value.

12. The distribution terminal according to claim 3,
wherein the processor
controls the communication unit such that a plurality of contents are transmitted to the acquisition terminal, in a case in which the number of acquisitions is not greater than an upper limit value, and
controls the communication unit such that contents other than contents set in advance in the plurality of contents are transmitted to the acquisition terminal, as the transmission limit of the contents, in a case in which the number of acquisitions is greater than the upper limit value.

13. The distribution terminal according to claim 4,
wherein the processor
controls the communication unit such that a plurality of contents are transmitted to the acquisition terminal, in a case in which the number of acquisitions is not greater than an upper limit value, and
controls the communication unit such that contents other than contents set in advance in the plurality of contents are transmitted to the acquisition terminal, as the transmission limit of the contents, in a case in which the number of acquisitions is greater than the upper limit value.

14. The distribution terminal according to claim 1,
wherein the processor
measures transmission amount of the contents being transmitted, for each fixed period,
continues the transmission limit of the contents, in a case in which the transmission amount is greater than a setting value when the transmission limit of the contents is performed with respect to the communication unit, and
releases the transmission limit of the contents, in a case in which the transmission amount is not greater than the setting value when the transmission limit of the contents is performed with respect to the communication unit.

15. The distribution terminal according to claim 1,
wherein the processor
measures a number of connections which is a number of acquisition terminals subjected to wireless communication connection with respect to the distribution terminal, for each fixed period,
continues the transmission limit of the contents, in a case in which the number of connections is greater than a setting value when the transmission limit of the contents is performed with respect to the communication unit, and
releases the transmission limit of the contents, in a case in which the number of connections is not greater than the setting value when the transmission limit of the contents is performed with respect to the communication unit.

16. A distribution system, comprising:
an acquisition terminal; and
a distribution terminal,
wherein the distribution terminal includes,
a communication unit that receives a request transmitted from the acquisition terminal before wireless communication connection is established, and transmits contents to the acquisition terminal after the wireless communication connection is established, and
a processor that controls the communication unit such that transmission limit of the contents is performed based on a number of acquisition terminals when the request is received.

17. A distribution method implemented by a distribution terminal, the distribution method comprising:
receiving a request transmitted from an acquisition terminal before wireless communication connection is established, using a processor of the distribution terminal; and
performing transmission limit of contents transmitted to the acquisition terminal after the wireless communication connection is established based on a number of acquisition terminals when the request is received, using the processor.
